(19) United States
(12) Patent Application Publication
(10) Pub. No.: US 2025/0389929 A1
(43) Pub. Date: Dec. 25, 2025

(54) OPTICAL SYSTEM AND IMAGING APPARATUS INCLUDING SAME

(71) Applicant: CANON KABUSHIKI KAISHA, Tokyo (JP)

(72) Inventor: TAKAHIRO SAITO, Tochigi (JP)

(21) Appl. No.: 19/243,548

(22) Filed: Jun. 19, 2025

(30) Foreign Application Priority Data
Jun. 24, 2024 (JP) 2024-101168

(51) Int. Cl. G02B 9/64

(52) U.S. Cl. CPC G02B 9/64

(57) ABSTRACT

The optical system includes a first lens group having positive refractive power, a second lens group having positive refractive power, and a third lens group, the first, second, and third lens groups being arranged in order from an object side to an image side. The second lens group is configured to move relative to an image plane in an optical axis direction during focusing, and the first and third lens groups are configured to remain stationary with respect to the image plane during focusing. The first lens group includes three negative lenses that are consecutively arranged in the optical axis direction and located closest to an object plane. The second lens group includes two or more lenses.

### BACKGROUND

### Technical Field

The aspect of the embodiments relates to an optical system and an imaging apparatus including the same, and is suitable for imaging apparatuses such as a digital video camera, a digital still camera, a broadcasting camera, a silver halide film camera, a surveillance camera, and an on-vehicle camera.

### Description of the Related Art

Optical systems are used in imaging apparatuses such as digital still cameras and video cameras using solid-state image sensors. There has recently been a demand for optical systems that are compact yet capable of focusing at closer distances. Japanese Patent Application Laid-Open No. 2023-008471 discusses an optical system consisting of a first lens group having positive refractive power, a second lens group having positive refractive power, and a third lens group having positive refractive power, which are arranged in order from an object side to an image side. The second lens group is configured to move relative to an image plane during focusing.

### SUMMARY

According to an aspect of the embodiments, an optical system includes a first lens group having positive refractive power, a second lens group having positive refractive power, and a third lens group, the first, second, and third lens groups being arranged in order from an object side to an image side, wherein the second lens group is configured to move relative to an image plane in an optical axis direction during focusing, and the first and third lens groups are configured to remain stationary with respect to the image plane during focusing, wherein the first lens group includes three negative lenses that are consecutively arranged in the optical axis direction and located closest to an object plane, wherein the second lens group includes two or more lenses, and wherein the following conditional expressions are satisfied: 0.50<f2/f<3.00, 0.20<sk/f≤1.075, and 0.00<sk/|f3|<0.80, where f is a focal length of the entire optical system, sk is an air-equivalent back focus in a case where the optical system is focused at infinity, f2 is a focal length of the second lens group, and f3 is a focal length of the third lens group.

According to another aspect of the disclosure, an apparatus includes the foregoing optical system.

Further features of the disclosure will become apparent from the following description of exemplary embodiments with reference to the attached drawings.

### BRIEF DESCRIPTION OF THE DRAWINGS

FIG. 1 is a sectional view of an optical system of example 1 when the optical system is focused at infinity.

FIGS. 2A and 2B are longitudinal aberration diagrams of the optical system of example 1 when the optical system is focused at (A) infinity and (B) a distance with a lateral magnification of −0.1, respectively.

FIG. 3 is a sectional view of an optical system of example 2 when the optical system is focused at infinity.

FIGS. 4A and 4B are longitudinal aberration diagrams of the optical system of example 2 when the optical system is focused at (A) infinity and (B) a distance with a lateral magnification of −0.1, respectively.

FIG. 5 is a sectional view of an optical system of example 3 when the optical system is focused at infinity.

FIGS. 6A and 6B are longitudinal aberration diagrams of the optical system of example 3 when the optical system is focused at (A) infinity and (B) a distance with a lateral magnification of −0.1, respectively.

FIG. 7 is a sectional view of an optical system of example 4 when the optical system is focused at infinity.

FIGS. 8A and 8B are longitudinal aberration diagrams of the optical system of example 4 when the optical system is focused at (A) infinity and (B) a distance with a lateral magnification of −0.1, respectively.

FIG. 9 is a sectional view of an optical system of example 5 when the optical system is focused at infinity.

FIGS. 10A and 10B are longitudinal aberration diagrams of the optical system of example 5 when the optical system is focused at (A) infinity and (B) a distance with a lateral magnification of −0.1, respectively.

FIG. 11 is a sectional view of an optical system of example 6 when the optical system is focused at infinity.

FIGS. 12A and 12B are longitudinal aberration diagrams of the optical system of example 6 when the optical system is focused at (A) infinity and (B) a distance with a lateral magnification of −0.1, respectively.

FIG. 13 is a sectional view of an optical system of example 7 when the optical system is focused at infinity.

FIGS. 14A and 14B are longitudinal aberration diagrams of the optical system of example 7 when the optical system is focused at (A) infinity and (B) a distance with a lateral magnification of −0.1, respectively.

FIG. 15 is a schematic diagram illustrating an imaging apparatus.

FIG. 16 is a schematic diagram illustrating a lens apparatus.

### DESCRIPTION OF THE EMBODIMENTS

An exemplary embodiment of the disclosure will be described in detail below with reference to the drawings. For the sake of convenience, the drawings may be drawn at scales different from actual sizes. In the drawings, similar members are denoted by the same reference numerals, and a redundant description thereof will be omitted.

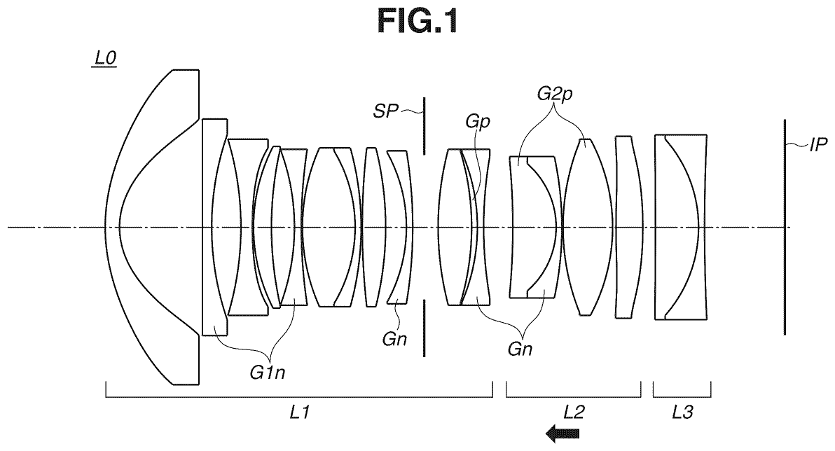

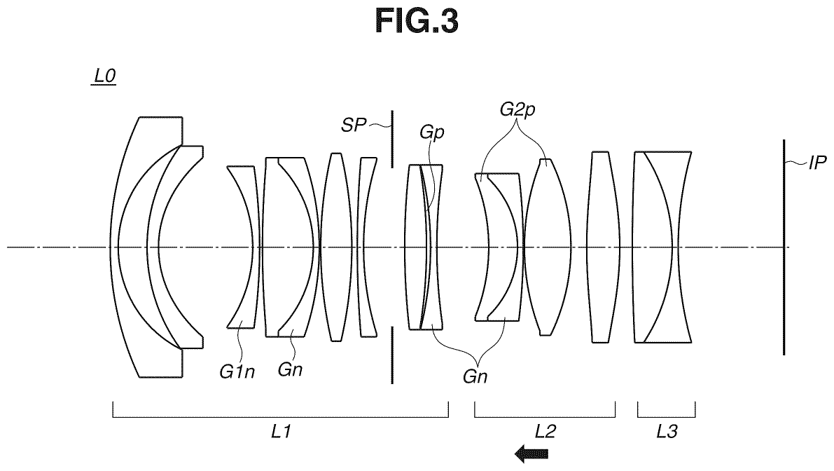

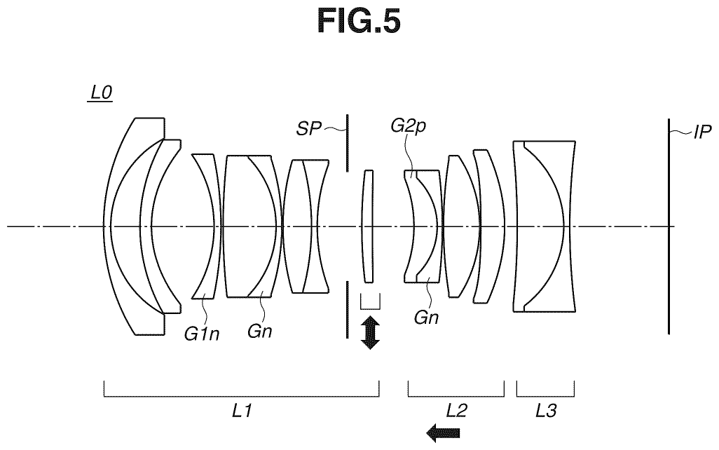

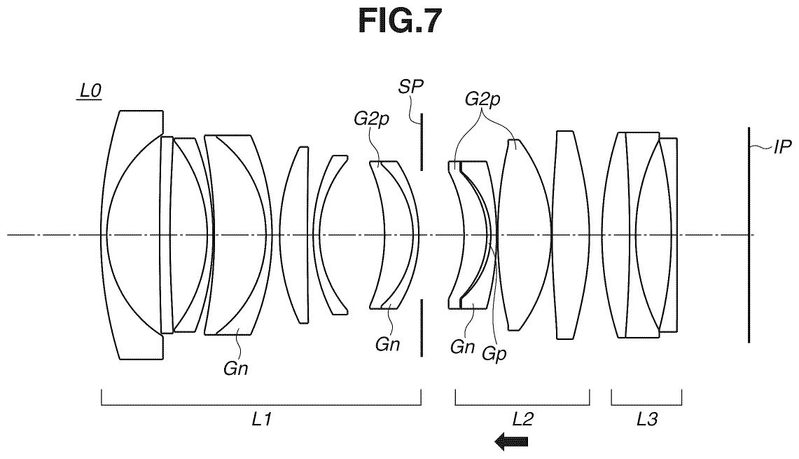

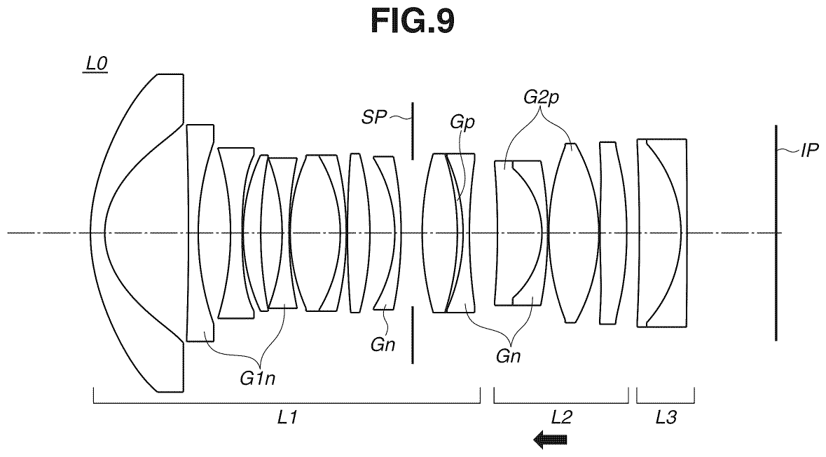

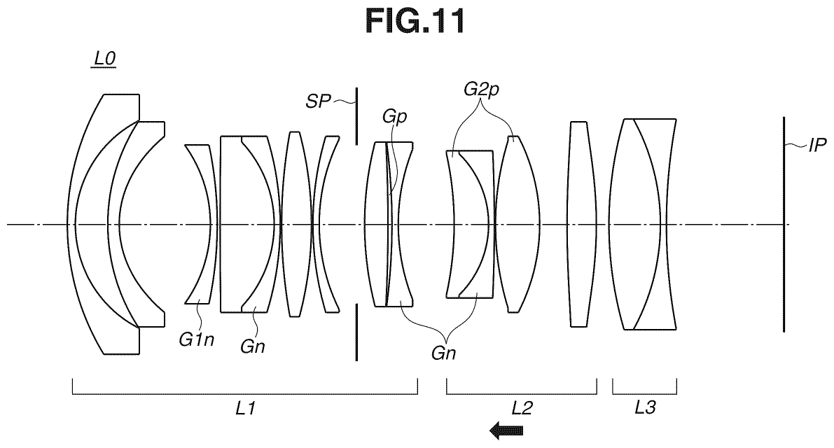

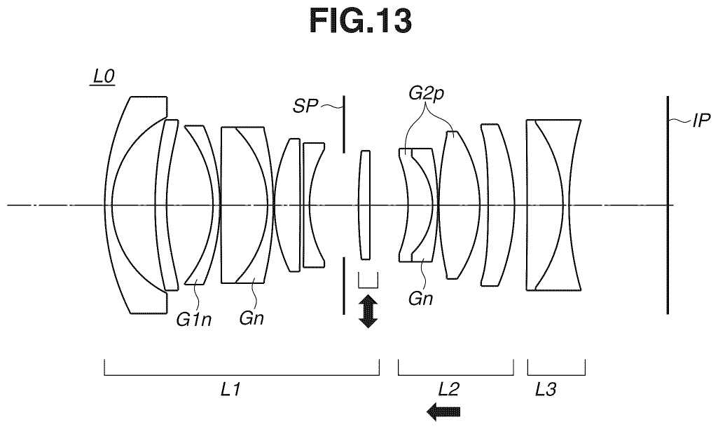

FIGS. 1, 3, 5, 7, 9, 11, and 13 are sectional views of optical systems of examples 1, 2, 3, 4, 5, 6, and 7, respectively, when the optical systems are focused at infinity.

In each of the sectional views, an object side is on the left, and an image side is on the right. The optical systems according to the examples are suitable for imaging apparatuses such as a digital video camera, a digital still camera, a broadcasting camera, a silver halide film camera, a surveillance camera, and an on-vehicle camera. The optical systems according to the examples may be used as a projection lens of a projector, in which case a screen side is on the left and an image to be projected side is on the right.

In each sectional view, the entire optical system is denoted by L0, and an ith (i is a natural number) lens group from the object side among lens groups divided between the object side and the image side by an aperture stop is denoted by Li. A kth (k is a natural number) lens from the object side among the lenses included in each lens group is denoted by Gk. As employed herein, the interior of a lens group refers to the space between the lens located closest to an object plane and the lens located closest to an image plane among the lenses constituting the lens group.

A lens group Li is a group of lenses that are integrally moved or fixed relative to the image plane during focusing. In other words, air gaps between adjacent lens groups vary during focusing. Air gaps within each lens group do not vary during focusing.

The arrow parallel to the optical axis in each sectional view indicates the moving direction of the lens group during focusing from infinity to the closest distance. In each example, only the second lens group L2 to be described below moves from the image side to the object side during focusing.

In each sectional view, an aperture stop SP determines the light beam at an open F-number. When the optical system of each example is used as an imaging optical system of a digital still camera or a digital video camera, the imaging surface of a solid-state image sensor or photoelectric conversion element, such as a charge-coupled device (CCD) sensor and a complementary metal-oxide-semiconductor (CMOS) sensor, is located on an image plane IP. The optical system L0 of each example may be used as an imaging optical system of a silver halide film camera, in which case a photosensitive surface corresponding to a film surface is located on the image plane IP.

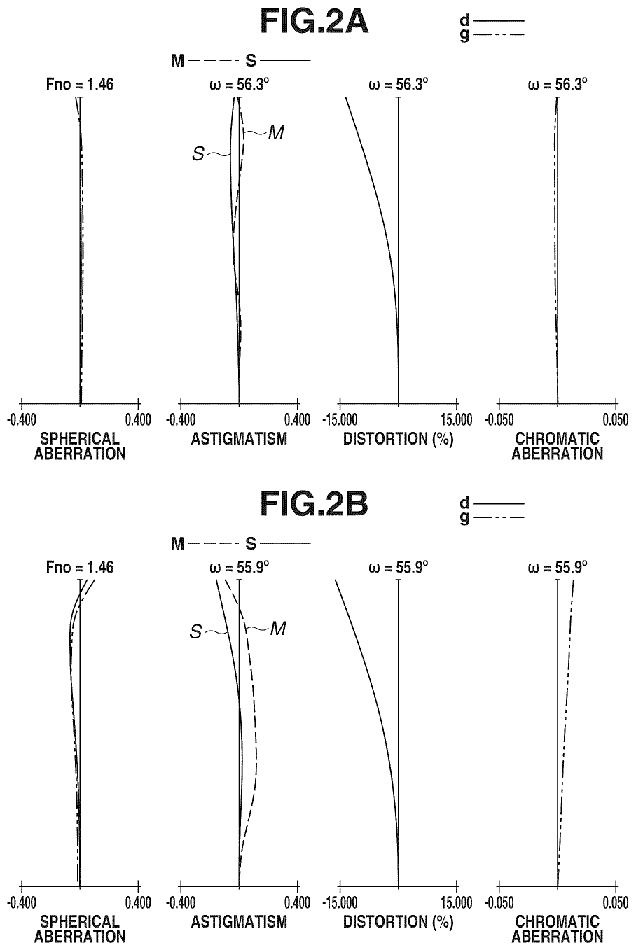

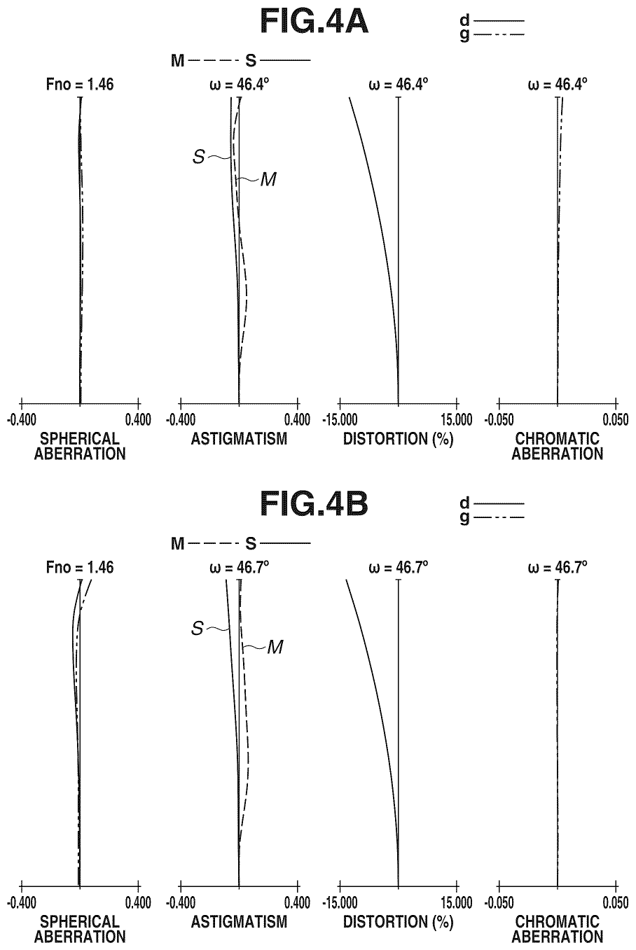

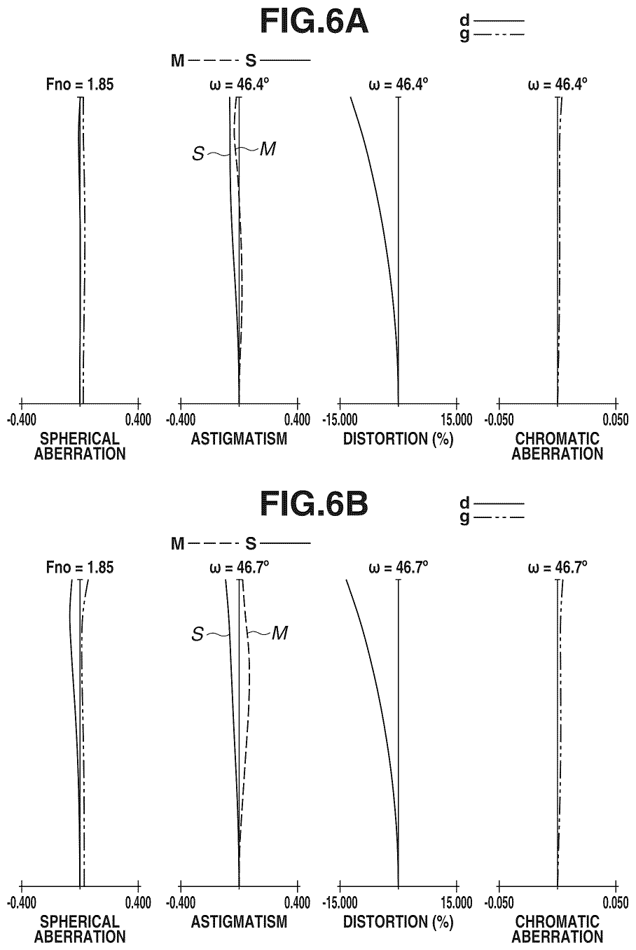

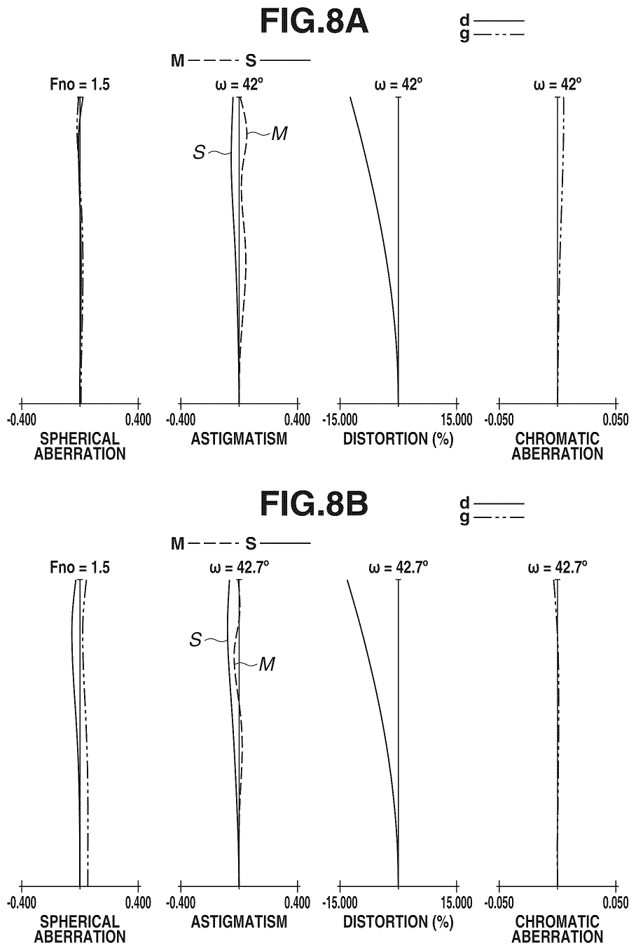

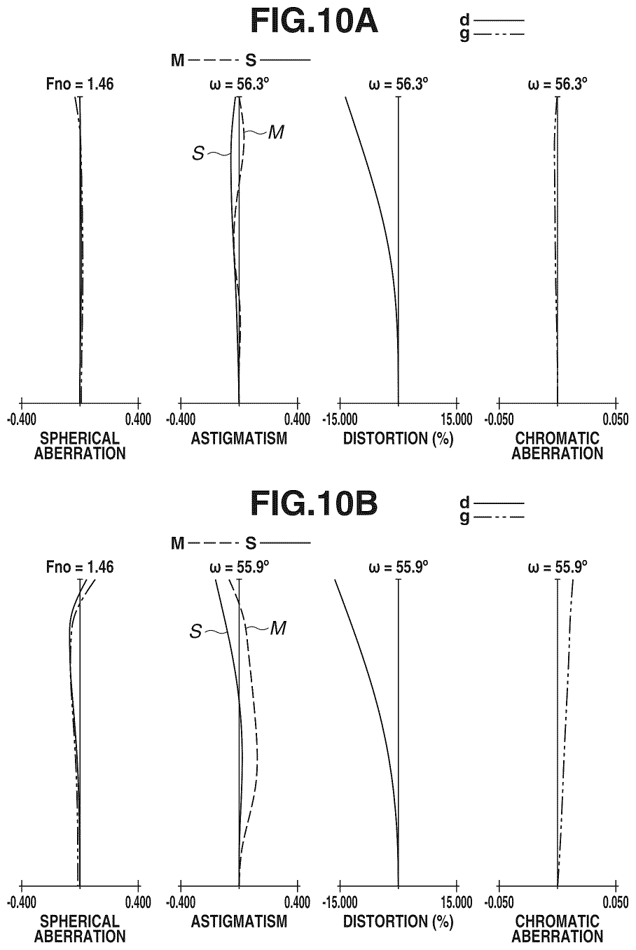

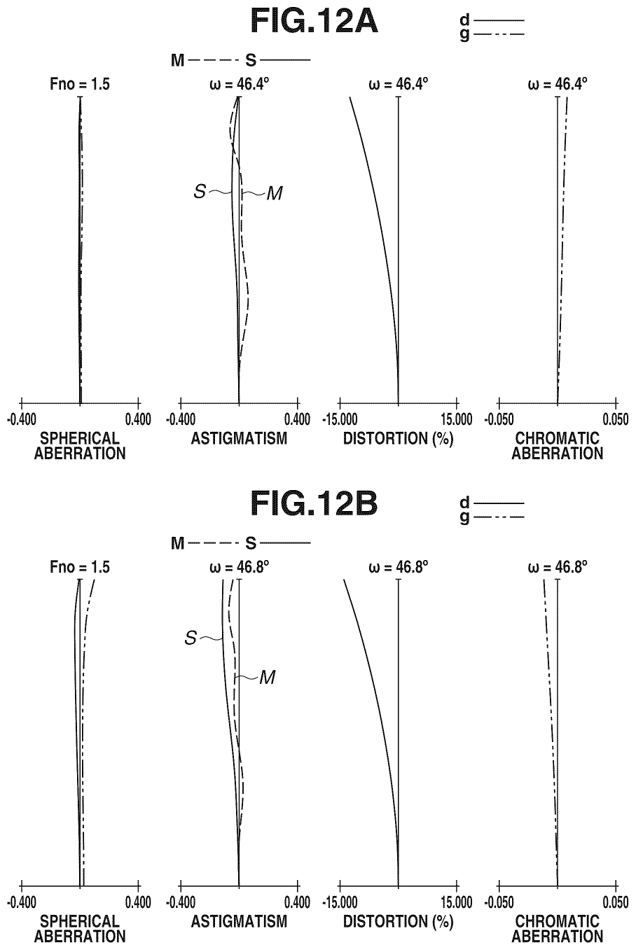

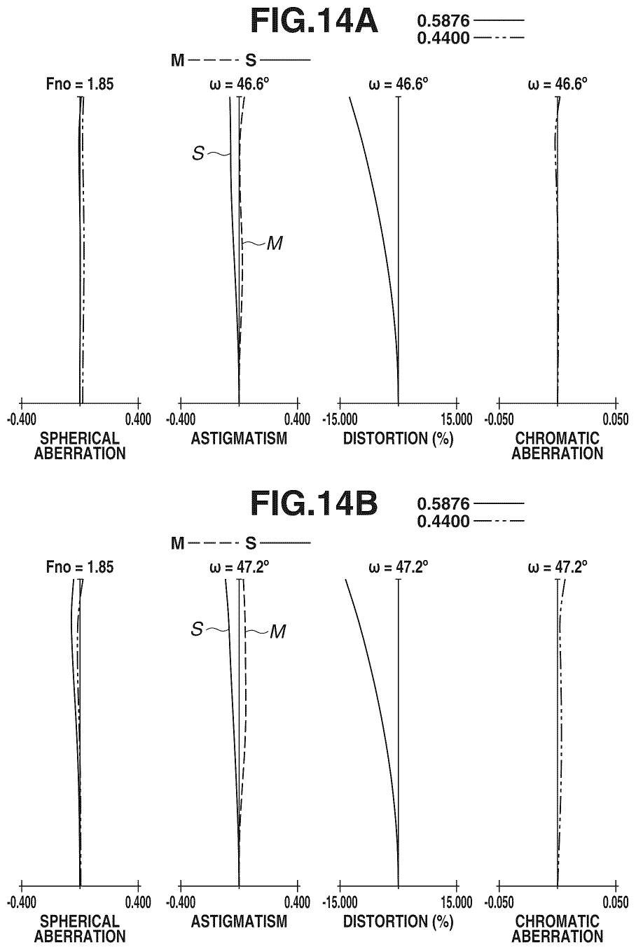

FIGS. 2A and 2B, 4A and 4B, 6A and 6B, 8A and 8B, 10A and 10B, 12A and 12B, and 14A and 14B are aberration diagrams when the optical systems LO of examples 1, 2, 3, 4, 5, 6, and 7 are focused at (A) infinity and (B) a distance with a lateral magnification of −0.1, respectively.

In spherical aberration diagrams, the F-number is denoted by Fno. The solid line represents the amount of spherical aberration on the d-line (wavelength: 587.6 nm), and the doubled-dotted dashed line the amount of spherical aberration on the g-line (wavelength: 435.8 nm). In the astigmatism diagrams, the solid line S represents the amount of astigmatism on the sagittal image plane, and the broken line M the amount of astigmatism on the meridional image plane. In the distortion aberration diagrams, the solid line represents the amount of distortion aberration on the d-line. In the chromatic aberration diagrams, the double-dotted dashed line represents the amount of magnification chromatic aberration on the g-line. The half angle of view for imaging (°) is denoted by ω.

Next, a characteristic configuration of the optical system according to each example will be described.

The optical system L0 of each example consists of a first lens group L1 having positive refractive power, a second lens group L2 having positive refractive power, and a third lens group L3, which are arranged in order from the object side to the image side. In the optical system L0 of each example, the second lens group L2 moves relative to the image plane IP in the optical axis direction during focusing. The first and third lens groups L1 and L3 remain stationary with respect to the image plane IP during focusing.

The optical system LO is configured so that the light beam converged by the first lens group L1 having positive refractive power is incident on the second lens group L2 having positive refractive power. This allows for a reduction in the lens diameter of the second lens group L2 that moves relative to the image plane IP during focusing, and can reduce the weight of the second lens group L2 for high-speed focusing.

The optical system L0 of each example is characterized in that the following conditional expression is satisfied:

$$0.5 < f 2 / f < 3. , \qquad ( 1 )$$

where f is the focal length of the entire optical system L0, and f2 is the focal length of the second lens group L2.

Conditional expression (1) relates to the refractive power of the second lens group L2. Satisfying conditional expression (1) makes the focal length f2 of the second lens group L2 small, whereby object distances capable of focusing can be brought closer to the image plane IP. Moreover, the overall length of the optical system LO can be reduced while reducing changes in optical performance during focusing.

If the focal length f2 of the positive second lens group L2 decreases to fall below the lower limit of conditional expression (1), the refractive power of the second lens group L2 is too high. This undesirably increases performance changes such as variations in the spherical aberration, field curvature, and angle of view occurring during focusing.

If the focal length f2 of the positive second lens group L2 increases to exceed the upper limit of conditional expression (1), the position sensitivity of the second lens group L2, i.e., the ratio of the amount of movement of the image plane IP to the amount of movement of the focus group is too low. This undesirably makes object distances capable of focusing farther from the image plane IP. Moreover, to secure air gaps for focusing, the overall length of the optical system L0 increases undesirably.

The numerical range of conditional expression (1) is replaced with that of the following conditional expression (1a):

$$0.7 < f 2 / f < 2.8 . \qquad ( 1 a )$$

The numerical range of conditional expression (1) is replaced with that of the following conditional expression (1b):

$$0.9 < f 2 / f < 2.6 . \qquad ( 1 b )$$

The numerical range of conditional expression (1) is replaced with that of the following conditional expression (1c):

$$1.1 < f 2 / f < 2.4 . \qquad ( 1 c )$$

Next, a configuration satisfied in the optical system L0 of each example will be described.

In the optical system L0, the first lens group L1 includes three negative lenses that are consecutively arranged in the optical axis direction and located closest to an object plane. To provide a sufficient back focus for a wide-angle lens, a high negative refractive power on the object side of the optical system L0 may be necessary.

Distributing the negative refractive power among the three negative lenses can reduce the refractive power per single negative lens, whereby the occurrence of barrel distortion aberration and field curvature can be suppressed. In the present exemplary embodiment, three consecutively arranged negative lenses mean that there is no positive lens disposed between the three negative lenses.

The third lens group L3 is located on the image side of the second lens group L2 that moves during focusing, at a position where the axial light beam and the peripheral light beam are sufficiently separated in the direction orthogonal to the optical axis. This can favorably correct astigmatism and distortion aberration for improved peripheral performance of the optical system L0.

In the optical system L0, the positive second lens group L2 includes at least two positive lenses and at least one negative lens. To reduce the amount of movement of the second lens group L2 during focusing from infinity to the closest distance, the second lens group L2 is to be high refractive power. Distributing this high refractive power between the at least two positive lenses can reduce the refractive power per single positive lens, whereby variations in the spherical aberration and field curvature during focusing can be reduced. The inclusion of at least one negative lens can favorably correct axial chromatic aberration.

In the optical system L0, the aperture stop SP for determining the axial light beam is located inside the first lens group L1 or next to the image side of the first lens group L1, and remains stationary with respect to the image plane IP during focusing. This enables high-speed focusing since the weight of the second lens group L2 that moves during focusing can be reduced. With the aperture stop SP located inside the first lens group L1 or next to the image side thereof, imbalance in lens diameter between the front and rear portions of the optical system L0 can be reduced. This can reduce the diameter of the entire optical system L0.

In the optical system L0, the lens located closest to the object plane in the second lens group L2 has a concave object-side lens surface. This makes the off-axis light beam passed through the aperture stop SP substantially concentrically incident on the surface closest to the object plane in the second lens group L2, with a reduction in the refraction of rays at the surface. As a result, variations in the astigmatism, comatic aberration, and angle of view during focusing can be reduced.

In the optical system L0, the lens located closest to the image plane in the second lens group L2 has a convex image-side lens surface. This makes the off-axis light beam emitted from the second lens group L2 substantially concentric with respect to the surface closest to the image plane in the second lens group L2, with a reduction in the refraction of rays at the surface. This facilitates reducing variations in the astigmatism, comatic aberration, and angle of view during focusing.

In the optical system L0, a negative lens is located closest to the image plane in the third lens group L3, i.e., closest to the image plane in the optical system L0. This can increase the angle that off-axis rays incident on the image plane IP form with the optical axis, allowing for a reduction in the lens diameter of the third lens group L3. Since the negative lens is located at a position where the off-axis ray height is large on the image side, the positive Petzval sum of the entire optical system L0 can be reduced without deteriorating the sagittal flare, whereby field curvature can be favorably corrected.

In the optical system discussed in Japanese Patent Application Laid-Open No. 2023-008471, the refractive power of the positive second lens group that moves during focusing is small. This makes object distances where the optical system focuses by focusing far from the image plane. Moreover, various aberrations occurring during focusing become difficult to correct.

Next, conditions satisfied by the optical system L0 of each example will be described.

The optical system L0 of each example satisfies one or more of the following conditional expressions (2) to (17):

$$0.2 < sk / f < 1.2 , \qquad ( 2 )$$

$$0.3 < f 1 / f 2 < 3. , \qquad ( 3 )$$

$$- 1.5 < f / f 3 < 1.5 , \qquad ( 4 )$$

$$- 1.5 < ( R 22 - R 21 ) / ( R 22 + R 21 ) < 1.5 , \qquad ( 5 )$$

$$- 0.015 < Δθ gFn < 0.015 , \qquad ( 6 )$$

$$- 0.2 < Ndn - ( - 0.0145425 \times vdn + 2.28725 ) < 0.05 , \qquad ( 7 )$$

$$0.5 < ( 1 - {β2}^{2} ) \times {β3}^{2} < 2.5 , \qquad ( 8 )$$

$$0. < sk / \vert f 3 \vert < 0.8 , \qquad ( 9 )$$

$$0.2 < \sum Dair / ( L - sk ) < 0.7 , \qquad ( 10 )$$

$$2. < L / f < 15. , \qquad ( 11 )$$

$$60. < vd 2 p < 100. , \qquad ( 12 )$$

$$- 0.2 < M 2 / DSP < - 0.005 , \qquad ( 13 )$$

$$60. < vd 1 n < 100. , \qquad ( 14 )$$

$$0.05 < Δθ gFp < 0.25 , \qquad ( 15 )$$

$$0.3 < ( DSP + sk ) / L < 0.8 , and \qquad ( 16 )$$

$$0.5 < f 1 / f < 5. . \qquad ( 17 )$$

In conditional expressions (2) to (17), various numerical values are expressed as follows.
sk is the air-equivalent back focus of the optical system L0.
f3 is the focal length of the third lens group L3.
R21 is the radius of curvature of the surface closest to the object plane in the second lens group L2, and R22 is the radius of curvature of the surface closest to the image plane.
Ndn is the refractive index of a negative lens Gn included in the optical system L0 on the d-line.
ΔθgFn is the anomalous partial dispersion of the negative lens Gn included in the optical system L0, given by:

$$Δθ gFn = θ gFn - ( - 0.0025116 \times vdn + 0.67449 ) ,$$

where vdn is the Abbe number, and θgFn is the partial dispersion ratio on the g- and F-lines.
β2 is the lateral magnification of the second lens group L2 when the optical system L0 is focused at infinity, and β3 is the lateral magnification of the third lens group L3 when the optical system L0 is focused at infinity.
ΣDair is the summation of air gaps on the optical axis from the surface closest to the object plane to the surface closest to the image plane in the optical system L0.
L is the total optical length of the optical system L0.
vd1n is the Abbe number of a negative lens G1n included in the first lens group L1.
vd2p is the Abbe number of a positive lens G2p included in the second lens group L2.
M2 is the amount of movement of the second lens group L2 during focusing from infinity to an object distance where the lateral magnification of the entire system is −0.1 times.
DSP is the distance on the optical axis from the aperture stop SP to the surface closest to the image plane in the optical system L0 when the optical system L0 is focused at infinity.
ΔθgFp is the anomalous partial dispersion of a positive lens Gp included in the first lens group L1 or the second lens group L2, given by:

$$Δθ gFp = θ gFp - ( B 3 \times {vdp}^{3} + B 2 \times {vdp}^{2} + B 1 \times vdp + B 0 ) ,$$

$$where$$

$$B 3 = - 1.665 \times {10}^{- 7} ,$$

$$B 2 = 5.213 \times {10}^{- 5} ,$$

$$B 1 = - 5.656 \times {10}^{- 3} , and$$

$$B 0 = 7.278 \times {10}^{- 1} ,$$

and where vdp is the Abbe number, and θgFp is the partial dispersion ratio.

Next, the technical meanings of the foregoing conditional expressions (2) to (17) will be described.

Conditional expression (2) relates to the air-equivalent back focus sk of the optical system L0. With conditional expression (2) satisfied, the third lens group L3 can be located at a position where the off-axis ray height is large. This enables selective correction of distortion aberration and astigmatism while minimizing the impact on the correction of spherical aberration and sagittal flare. As a result, the peripheral performance of the optical system L0 can be improved.

If the back focus sk falls below the lower limit or exceeds the upper limit of conditional expression (2), the third lens group L3 is difficult to located at a position where the off-axis ray height is large. This is undesirable because distortion aberration, field curvature, and astigmatism become difficult to correct sufficiently.

Conditional expression (3) relates to the ratio of the refractive power of the first lens group L1 and that of the second lens group L2.

If f2 increases and the ratio falls below the lower limit of conditional expression (3), the positive refractive power of the second lens group L2 is too low, which undesirably increases the amount of movement during focusing and increases the overall length. Small f1 is undesirable since spherical aberration and axial chromatic aberration become difficult to correct.

If f2 decreases and the ratio exceeds the upper limit of conditional expression (3), the positive refractive power of the second lens group L2 is too large. This is undesirable because performance changes such as variations in the spherical aberration, field curvature, and angle of view during focusing become too large. Large f1 is undesirable since the overall length increases.

Conditional expression (4) defines the ratio of the focal length f3 of the third lens group L3 and the focal length f of the entire optical system L0.

In the vicinity of the lower limit of conditional expression (4), f3 has a negative value. If the absolute value of f3 increases and the ratio falls below the lower limit of conditional expression (4), the negative refractive power of the third lens group L3 is too high. This makes the incident angle of the off-axis light beam incident on the image plane IP too large, which is undesirable since color unevenness occurs easily when an image is captured using a solid-state image sensor such as a CMOS sensor.

In the vicinity of the upper limit of conditional expression (4), f3 has a positive value. If the absolute value of f3 decreases and the ratio exceeds the upper limit of conditional expression (4), the positive refractive power of the third lens group L3 is too high. This makes the positive Petzval sum of the entire optical system L0 too large, which is undesirable since field curvature becomes difficult to correct.

Conditional expression (5) defines the shape of the second lens group L2, and relates to a condition for reducing variations in aberrations and the angle of view occurring during focusing.

Below the lower limit of conditional expression (5), the radius of curvature of the concave surface closest to the object plane in the second lens group L2 has a large absolute value. Here, the concentricity of the surface closest to the object plane in the second lens group L2 with respect to the off-axial light beam incident on the second lens group L2 drops. Moreover, the radius of curvature of the convex surface closest to the image plane in the second lens group L2 has a small absolute value, and the off-axis light beam is significantly refracted at the surface closest to the image plane in the second lens group L2. This is undesirable since variations in the angle of view occurring during focusing tend to be large.

Above the upper limit of conditional expression (5), the radius of curvature of the concave surface closest to the object plane in the second lens group L2 has a small absolute value. Here, the concentricity of the surface closest to the object plane in the second lens group L2 with respect to the off-axis light beam incident on the second lens group L2 drops. As a result, variations in the angle of view occurring during focusing tend to be large. Moreover, the radius of curvature of the convex surface closest to the image plane in the second lens group L2 has a large absolute value. This is undesirable since aberration variations such as comma aberration and astigmatism during focusing tend to be large.

Conditional expression (6) defines the anomalous partial dispersion of a negative lens Gn included in the first lens group L1 or the second lens group L2.

Below the lower limit of conditional expression (6), the axial chromatic aberration on the g-line is undesirably overcorrected.

Above the upper limit of conditional expression (6), the axial chromatic aberration on the g-line is undesirably undercorrected.

Conditional expression (7) defines the dispersion of a negative lens Gn included in at least one of the first lens group L1 and the second lens group L2.

Below the lower limit of conditional expression (7), axial chromatic aberration is undesirably overcorrected.

Above the upper limit of conditional expression (7), axial chromatic aberration is undesirably undercorrected or the refractive power of the negative lens Gn is so high that spherical aberration becomes difficult to correct.

Large-diameter lenses tend to have an issue with the axial chromatic aberration at shorter wavelengths such as the g-line. In particular, primary achromatization on the C-and F-lines tends to result in excessive axial chromatic aberration on the g-line. The use of lens materials satisfying conditional expressions (6) and (7) for negative lenses can relatively reduce the degree of divergence of the g-line through the negative lenses, whereby the axial chromatic aberration at shorter wavelengths such as the g-line can be prevented from becoming excessive.

The foregoing effect for correcting the axial chromatic aberration can be obtained by disposing at least one negative lens Gn satisfying both conditional expressions (6) and (7) in at least one of the first and second lens groups L1 and L2.

The effect can be enhanced by including two negative lenses Gn. The effect can be further enhanced by including three or more negative lenses Gn.

The lenses Gn are disposed at least one in the first lens group L1 and at least one in the second lens group L2.

The inclusion of the negative lens(es) Gn in the first lens group L1 can effectively correct the axial chromatic aberration of the entire optical system L0. The inclusion of the negative lens(es) Gn in the second lens group L2 facilitates the correction of the axial chromatic aberration inside the second lens group L2, whereby variations in the axial chromatic aberration during focusing can be reduced.

Conditional expression (8) relates to the position sensitivity of the second lens group L2, and defines the ratio of the amount of movement of the image plane IP to that of the second lens group L2.

Below the lower limit of conditional expression (8), the position sensitivity of the second lens group L2 is too low.

As a result, distances that enable focusing become undesirably long. This is also undesirable because, for the sake of securing air gaps for focusing, the overall length of the optical system L0 is difficult to reduce.

Above the upper limit of conditional expression (8), the refractive power of the second lens group L2 is too high. This is undesirable because performance changes such as variations in the spherical aberration, field curvature, and angle of view during focusing become too large.

Conditional expression (9) defines the ratio of the focal length f3 of the third lens group L3 and the air-equivalent back focus sk.

If sk decreases to fall below the lower limit of conditional expression (9), the image plane IP of the optical system L0 falls on the object side of the surface closest to the image plane in the optical system L0. This is undesirable because imaging is difficult.

If sk increases to exceed the upper limit of conditional expression (9), it is undesirable because the effect of correcting distortion aberration and field curvature decreases, or the diameter of the front lens elements increases.

If |f3| decreases and the ratio exceeds the upper limit of conditional expression (9), the absolute value of the refractive power of the third lens group L3 is too large. Too high a negative refractive power is undesirable because the incident angle of the off-axis light beam incident on the image plane IP is too large and color unevenness occurs easily when an image is captured using an image sensor such as a CMOS sensor. Too high a positive refractive power is undesirable because the positive Petzval sum of the entire optical system L0 is so large that field curvature becomes difficult to correct.

Conditional expression (10) defines the ratio of the summation ΣDair of air gaps on the optical axis from the surface closest to the object plane to the surface closest to the image plane in the optical system L0 and the total optical length L of the optical system L0.

If ΣDair decreases to fall below the lower limit of conditional expression (10), a sufficient space for the lens group to move during focusing is difficult to provide. This is undesirable because the negative lenses included in the first lens group L are difficult to configure with sufficient positive curvatures, and it is difficult to configure a wide-angle optical system L0 or correct the distortion aberration.

If ΣDair increases to exceed the upper limit of conditional expression (10), the ratio of the air gaps to the total optical length is too high. This is undesirable because the lenses are difficult to configure with sufficient refractive power, and spherical aberration and axial chromatic aberration become difficult to correct. In other words, the overall length increases undesirably if the lenses are configured with sufficient refractive power.

Conditional expression (11) defines the ratio of the total optical length L of the optical system L0 to the focal length f of the entire optical system L0.

If L decreases to fall below the lower limit of conditional expression (11), the refractive power of the lens groups is too high. This is undesirable because aberrations such as distortion aberration, astigmatism, and spherical aberration become difficult to correct.

If L increases to exceed the upper limit of conditional expression (11), the overall length increases undesirably.

Conditional expression (12) is an expression defining the Abbe number vd2p of at least one positive lens G2p included in the second lens group L2. Conditional expression (12) defines a condition for favorably correcting axial chromatic aberration.

If vd2p falls below the lower limit of conditional expression (12), it is undesirable because axial chromatic aberration becomes difficult to correct.

If vd2p exceeds the upper limit of conditional expression (12), it is undesirable because magnification chromatic aberration is overcorrected, or too high an abrasion degree of the lens material makes machining difficult or facilitates cracking.

Disposing two or more positive lenses G2p satisfying conditional expression (12) in the second lens group L2 is more desirable since the foregoing effect can be enhanced.

Conditional expression (13) defines the ratio of the amount of movement M2 of the second lens group L2 during focusing from infinity to an object distance where the lateral magnification of the entire system is −0.1 times and the distance DSP on the optical axis from the aperture stop SP to the surface closest to the image plane. The sign of the amount of movement M2 is positive when the second lens group L2 moves from the object side to the image side.

If M2 decreases to fall below the lower limit of conditional expression (13), the refractive power of the second lens group L2 is too high. This is undesirable because variations in spherical aberration and field curvature during focusing increase.

If M2 increases to exceed the upper limit of conditional expression (13), the amount of movement M2 of the second lens group L2 is too large. This undesirably increases the overall length to secure the moving space.

Conditional expression (14) is an expression defining the Abbe number vd1n of at least one negative lens Gln included in the first lens group L1. Conditional expression (14) defines a condition for favorably correcting magnification chromatic aberration.

If vd1n falls below the lower limit of conditional expression (14), it is undesirable because magnification chromatic aberration becomes difficult to correct.

If vd1n exceeds the upper limit of conditional expression (14), it is undesirable because magnification chromatic aberration is overcorrected, or too high an abrasion degree of the negative lens Gln makes machining difficult or facilitates cracking.

Disposing two or more negative lenses Gln satisfying conditional expression (14) in the first lens group L1 is more desirable since the foregoing effect can be enhanced.

Conditional expression (15) defines the anomalous partial dispersion ΔθgFp of a positive lens Gp included in the first lens group L1 or the second lens group L2.

Large-diameter lenses tend to have an issue with the axial chromatic aberration at shorter wavelengths such as the g-line. In particular, primary achromatization on the C-and F-lines tends to result in excessive axial chromatic aberration on the g-line. The use of materials with high ΔθgFp for positive lenses enables favorable correction by selectively converging the excessive axial chromatic aberration at shorter wavelengths such as the g-line.

If ΔθgFp falls below the lower limit of conditional expression (15), it is undesirable since the axial chromatic aberration becomes difficult to correct.

If ΔθgFp exceeds the upper limit of conditional expression (15), it is undesirable since the axial chromatic aberration is overcorrected.

The effect of correcting the axial chromatic aberration can be further enhanced by disposing the positive lens Gp in the form of a cemented triplet consisting of a positive lens, the positive lens Gp, and a negative lens, or a cemented triplet consisting of a negative lens, the positive lens Gp, and a positive lens.

The negative lens constituting the cemented triplet can be one satisfying conditional expressions (6) and (7), in which case the axial chromatic aberration can be effectively corrected.

The cemented triplet is located next to the object side or image side of the aperture stop SP disposed in the first lens group L1. The cemented triplet is thus located at a position where the axial ray height is large, which can enhance the effect of the axial chromatic aberration correction.

The cemented triplet and the aperture stop SP are disposed in the first lens group L1 that remains stationary during focusing. While the cemented triplet can be located in front of or behind the aperture stop SP as described above, the axial beam diameter is large in front of or behind the aperture stop SP, which results in a large lens diameter and increased lens weight. For such a reason, the aperture stop SP and the cemented triplet including the positive lens Gp are configured to be stationary during focusing.

Conditional expression (16) is an expression defining the position of the aperture stop SP, and defines a condition for miniaturizing the optical system L0.

If DSP decreases to fall below the lower limit of conditional expression (16), the lenses located on the object side of the aperture stop SP become large in diameter. This is undesirable because the mass and diameter of the entire optical system L0 increase. Moreover, the angle of the off-axis light beam incident on the image plane IP becomes too large, which is undesirable since color unevenness occurs easily when an image is captured using a solid-state image sensor such as a CMOS sensor.

If DSP increases to exceed the upper limit of conditional expression (16), the lenses located on the image side of the aperture stop SP become large in diameter. This is undesirable because the mass and diameter of the entire optical system L0 increase.

Conditional expression (17) defines the focal length f1 of the first lens group L1.

If f1 decreases to fall below the lower limit of conditional expression (17), the positive refractive power of the first lens group L1 is too high. This is undesirable since spherical aberration and distortion aberration become difficult to correct.

If f1 increases to exceed the upper limit of conditional expression (17), the diameter and mass of the second lens group L2 increase. This is undesirable because high-speed focusing becomes difficult.

The numerical ranges of conditional expressions (2) to (17) are replaced with those of the following conditional expressions (2a) to (17a):

$$0.3 < sk / f < 1.18 , \qquad ( 2 a )$$

$$0.5 < f 1 / f 2 < 2.7 , \qquad ( 3 a )$$

$$- 1.2 < f / f 3 < 1.2 , \qquad ( 4 a )$$

$$- 1.2 < ( R 22 - R 21 ) / ( R 22 + R 21 ) < 1.2 , \qquad ( 5 a )$$

$$- 0.01 < Δθ gFn < 0.01 , \qquad ( 6 a )$$

$$- 0.18 < Ndn - ( - 0.0145425 \times vdn + 2.28725 ) < 0.03 , \qquad ( 7 a )$$

$$0.6 < ( 1 - {β2}^{2} ) \times {β3}^{2} < 2.2 , \qquad ( 8 a )$$

$$0. < sk / \vert f 3 \vert < 0.7 , \qquad ( 9 a )$$

$$0.25 < \sum Dair / ( L - sk ) < 0.64 , \qquad ( 10 a )$$

$$3. < L / f < 13.5 , \qquad ( 11 a )$$

$$62. < vd 2 p < 99. , \qquad ( 12 a )$$

$$- 0.16 < M 2 / DSP < - 0.008 , \qquad ( 13 a )$$

$$62. < vd 1 n < 99. , \qquad ( 14 a )$$

$$0.06 < Δθ gFp < 0.21 , \qquad ( 15 a )$$

$$0.35 < ( DSP + sk ) / L < 0.74 , and \qquad ( 16 a )$$

$$0.7 < f 1 / f < 4.5 . \qquad ( 17 a )$$

The numerical ranges of conditional expressions (2) to (17) are more replaced with those of the following conditional expressions (2b) to (17b):

$$0.4 < sk / f < 1.14 , \qquad ( 2 b )$$

$$0.7 < f 1 / f 2 < 2.3 , \qquad ( 3 b )$$

$$- 0.9 < f / f 3 < 0.5 , \qquad ( 4 b )$$

$$- 0.8 < ( R 22 - R 21 ) / ( R 22 + R 21 ) < 0.8 , \qquad ( 5 b )$$

$$- 0.008 < Δθ gFn < 0.007 , \qquad ( 6 b )$$

$$- 0.15 < Ndn - ( - 0.0145425 \times vdn + 2.28725 ) < 0.02 , \qquad ( 7 b )$$

$$0.55 < ( 1 - {β2}^{2} ) \times {β3}^{2} < 1.9 , \qquad ( 8 b )$$

$$0. < sk / \vert f 3 \vert < 0.6 , \qquad ( 9 b )$$

$$0.3 < \sum Dair / ( L - sk ) < 0.56 , \qquad ( 10 b )$$

$$3.5 < L / f < 12. , \qquad ( 11 b )$$

$$64. < vd 2 p < 98. , \qquad ( 12 b )$$

$$- 0.12 < M 2 / DSP < - 0.012 , \qquad ( 13 b )$$

$$64. < vd 1 n < 98. , \qquad ( 14 b )$$

$$0.07 < Δθ gFp < 0.18 , \qquad ( 15 b )$$

$$0.4 < ( DSP + sk ) / L < 0.68 , and \qquad ( 16 b )$$

$$1. < f 1 / f < 4. . \qquad ( 17 b )$$

The numerical ranges of conditional expressions (2) to (17) are still more replaced with those of the following conditional expressions (2c) to (17c):

$$0.5 < sk / f < 1.1 , \qquad ( 2 c )$$

$$0.9 < f 1 / f 2 < 1.8 , \qquad ( 3 c )$$

$$- 0.5 < f / f 3 < 0.2 , \qquad ( 4 c )$$

$$- 0.5 < ( R 22 - R 21 ) / ( R 22 + R 21 ) < 0.5 , \qquad ( 5 c )$$

$$- 0.006 < Δθ gFn < 0.004 , \qquad ( 6 c )$$

$$- 0.13 < Ndn - ( - 0.0145425 \times vdn + 2.28725 ) < 0.01 , \qquad ( 7 c )$$

$$0.65 < ( 1 - {β2}^{2} ) \times {β3}^{2} < 1.6 , \qquad ( 8 c )$$

$$0. < sk / \vert f 3 \vert < 0.4 , \qquad ( 9 c )$$

$$0.33 < \sum Dair / ( L - sk ) < 0.5 , \qquad ( 10 c )$$

$$4. < L / f < 11. , \qquad ( 11 c )$$

$$66. < vd 2 p < 97. , \qquad ( 12 c )$$

$$- 0.08 < M 2 / DSP < - 0.016 , \qquad ( 13 c )$$

$$66. < vd 1 n < 97. , \qquad ( 14 c )$$

$$0.08 < Δθ gFp < 0.16 , \qquad ( 15 c )$$

$$0.45 < ( DSP + sk ) / L < 0.65 , and \qquad ( 16 c )$$

$$1.3 < f 1 / f < 3.5 . \qquad ( 17 c )$$

Next, detailed configurations of the optical systems L0 of examples 1 to 7 will be described. For the optical systems (zoom lenses) L0 of examples 2 to 7, a description of components similar to those of the zoom lens L0 of example 1 will be omitted, and differences from example 1 will mainly be described.

The optical system L0 of example 1 consists of a first lens group L1 having positive refractive power, a second lens group L2 having positive refractive power, and a third lens group L3 having negative refractive power. Configuring the third lens group L3 with negative refractive power facilitates correction of the positive Petzval sum, and field curvature can be favorably corrected.

In the optical system L0 of example 1, the first lens group L1 consists of lenses G1 to G12. The second lens group L2 consists of lenses G13 to G16. The third lens group consists of lenses G17 and G18. The first lens group L1 includes the aperture stop SP. The lenses G1 and G3 are configured as aspherical lenses, which can favorably correct distortion aberration and astigmatism.

In the optical system L0 of example 1, the lenses G6 and G7, the lenses G10 to G12, the lenses G13 and G14, and the lenses G17 and G18 are cemented to each other to constitute respective cemented lenses.

During focusing, the second lens group L2 moves relative to the image plane IP in the optical axis direction, and the first and third lens groups L1 and L2 remain stationary with respect to the image plane IP.

In the optical system L0 of example 2, the first lens group L1 consists of lenses G1 to G10. The second lens group L2 consists of lenses G11 to G14. The third lens group L3 consists of lenses G15 and G16.

In the optical system L0 of example 2, the lenses G4 and G5, the lenses G8 to G10, the lenses G11 and G12, and the lenses G15 and G16 are cemented to each other to form respective cemented lenses.

In the optical system L0 of example 3, the first lens group L1 consists of lenses G1 to G8. The second lens group L2 consists of lenses G9 to G12. The third lens group L3 consists of lenses G13 and G14. The first lens group L1 includes the aperture stop SP. The lenses G1 and G3 are configured as aspherical lenses, which can favorably correct distortion aberration and astigmatism.

In the optical system L0 of example 3, the lenses G4 and G5, the lenses G6 and G7, the lenses G9 and G10, and the lenses G13 and G14 are cemented to each other to form respective cemented lenses.

In the optical system L0 of example 3, the lens G8 included in the first lens group L1 moves in a direction that includes a component orthogonal to the optical axis. Variations in chromatic aberration can thereby be reduced during image stabilization correction.

In the optical system L0 of example 4, the first lens group L1 consists of lenses G1 to G9. The second lens group L2 consists of lenses G10 to G14. The third lens group L3 consists of lenses G15 to G17.

In the optical system L0 of example 4, the lenses G4 and G5, the lenses G8 and G9, the lenses G10 to G12, and the lenses G15 and G16 are cemented to each other to form respective cemented lenses.

In the optical system L0 of example 5, the first lens group L1 consists of lenses G1 to G12. The second lens group L2 consists of lenses G13 to G16. The third lens group L3 consists of lenses G17 and G18. The lenses G1 and G3 are configured as aspherical lenses, which can favorably correct distortion aberration and astigmatism.

In the optical system L0 of example 5, the lenses G6 and G7, the lenses G10 to G12, the lenses G13 and G14, and the lenses G17 and G18 are cemented to each other to form respective cemented lenses.

The optical system L0 of example 6 consists of a first lens group L1 having positive refractive power, a second lens group L2 having positive refractive power, and a third lens group L3 having positive refractive power. Configuring the third lens group L2 with positive refractive power can reduce the incident angle of the off-axis light beam incident on the image plane IP. This facilitates suppression of color unevenness when an image is captured using a solid-state image sensor such as a CMOS sensor.

In the optical system L0 of example 6, the first lens group L1 consists of lenses G1 to G10. The second lens group L2 consists of lenses G11 to G14. The third lens group L3 consists of lenses G15 and G16. The lenses G1 and G3 are configured as aspherical lenses, which can favorably correct distortion aberration and astigmatism.

In the optical system L0 of example 6, the lenses G4 and G5, the lenses G8 to G10, the lenses G11 and G12, and the lenses G15 and G16 are cemented to each other to form respective cemented lenses.

In the optical system L0 of example 7, the first lens group L1 consists of lenses G1 to G8. The second lens group L2 consists of lenses G9 to G12. The third lens group consists of lenses G13 and G14. The lenses G1 and G3 are configured as aspherical lenses, which can favorably correct distortion aberration and astigmatism.

In the optical system L0 of example 7, the lenses G4 and G5, the lenses G9 and G10, and the lenses G13 and G14 are cemented to each other to form respective cemented lenses.

In the optical system L0 of example 7, the lens G8 included in the first lens group L1 moves in a direction that includes a component orthogonal to the optical axis. Variations in chromatic aberration can thereby be reduced during image stabilization correction.

In the optical system L0 of each example, a negative lens is located closest to the image plane in the third lens group L3, i.e., closest to the image plane in the optical system L0. This can increase the angle that off-axis rays incident on the image plane IP form with the optical axis, and the lens diameter of the third lens group L3 can thus be reduced. Since the negative lens is located at a position where the off-axis ray height is large on the image side, the positive Petzval sum of the entire optical system L0 can be reduced without deteriorating sagittal flare, and field curvature can be favorably corrected.

In the optical system L0 of each example, the first lens group L1 includes two negative meniscus lenses with convex object-side lens surfaces, consecutively arranged and located closest to the object plane. This enables favorable correction of distortion aberration, field curvature, and astigmatism.

In the optical system L0 of each example, the first lens group L1 includes an aspherical lens as at least one of the three negative lenses consecutively arranged and located closest to the object plane. This enables favorable correction of distortion aberration and astigmatism. In examples 1 and 5, the two lenses G1 and G3 are configured as aspherical lenses to enhance the foregoing effect. Distortion aberration can be favorably corrected by shaping the aspherical lens(es) so that the peripheral curvature has an absolute value smaller than that of the curvature on the optical axis.

In the optical system L0 of each example, the negative lens G2 has a concave image-side lens surface, and the negative lens G3 a concave object-side lens surface. This increases the refractive power of the negative air lens constituted by the image-side lens surface of the lens G2 and the object-side lens surface of the lens G3. The positive Petzval sum can thus be easily reduced for favorable correction of field curvature.

In the optical system L0 of each example, the first lens group L1 includes a negative lens G1, a negative lens G2, a negative lens G3, and a positive lens G4 in order from the object side. Configuring the lens G4 as a positive lens can favorably correct barrel distortion aberration and magnification chromatic aberration occurring from the lenses G1 to G3.

In examples 1 and 5, the lens G4 is a meniscus lens having positive refractive power. This enables correction of barrel distortion aberration and magnification chromatic aberration. The lens G4 may be a positive meniscus lens with a convex object-side lens surface, or a positive meniscus lens with a convex image-side lens surface.

In the optical system L0 of each example, the first lens group L1 includes at least one cemented lens consisting of a positive lens and a negative lens. This can favorably correct axial chromatic aberration and magnification chromatic aberration. Like examples 2, 3, 4, 6, and 7, the axial chromatic aberration on the g-line can be more favorably corrected by configuring the negative lens in the cemented lens as a negative lens Gn satisfying conditional expressions (6) and (7).

In the optical system L0 of each example, the first lens group LI can implement image stabilization correction by moving at least a part of the first lens group L1 in a direction that includes a component orthogonal to the optical axis direction.

In examples 3 and 7, the lens G8 moves in the direction that includes a component orthogonal to the optical axis during image stabilization correction. However, this is not restrictive. At least a positive lens and a negative lens may be moved during image stabilization correction, in which case variations in chromatic aberration during image stabilization correction can be reduced. The optical system L0 may be configured to move three or more lenses during image stabilization correction.

In the optical system L0 of each example, the second lens group L2 includes a negative lens and a positive lens arranged in order in the optical axis direction. Axial chromatic aberration during infinity focusing and variations in axial chromatic aberration during focusing can thereby be more favorably corrected. This effect is obtained regardless of the order in which the negative and positive lenses are arranged.

In the second lens group L2, the lens located second closest to the object plane has a concave object-side lens surface, and the lens located closest to the image plane has a convex image-side lens surface. This results in a substantially concentric configuration with respect to the off-axis light beam incident on the second lens group L2, whereby variations in aberrations and the angle of view during focusing can be reduced.

In the optical system L0 of each example, the second lens group L2 includes a cemented lens formed by cementing at least one of negative lenses Gn and at least one of positive lenses G2p. This enables favorable correction of axial chromatic aberration during infinity focusing and variations in the axial chromatic aberration during focusing.

The cemented lens is located closest to the object plane in the second lens group L2.

Since the cemented lens is thus located at a position where the off-axis ray height is large, axial chromatic aberration can be favorably corrected.

In this cemented lens, a concave lens surface is located closest to the object plane, and a convex lens surface closest to the image plane. This results in a substantially concentric configuration with respect to the off-axis light beam incident on the second lens group L2, and variations in aberrations and the angle of view during focusing can be reduced. The cemented lens may be formed by cementing a biconcave lens and a biconvex lens in order from the object side.

In the optical system L0 of each example, the second lens group L2 consists of four lenses. This can reduce the refractive power per lens, and variations in spherical aberration, field curvature, and chromatic aberration during focusing can be reduced.

In the optical system L0 of each example, the second lens group L2 consists of five lenses or less. This can reduce the weight of the lenses in the second lens group L2, and enables high-seed focusing. Moreover, the refractive power per lens can be reduced to reduce variations in spherical aberration, field curvature, and chromatic aberration during focusing. To enhance the foregoing effect, the second lens group L2 consists of four lenses or less.

In the optical system L0 of each example, the lens located closest to the object plane in the second lens group L2 has a concave object-side lens surface. As a result, the off-axis light beam passed through the aperture stop SP is substantially concentrically incident on the surface closest to the object plane in the second lens group L2. This facilitates reducing variations in astigmatism, comatic aberration, and the angle of view during focusing.

In the optical system L0 of each example, the second lens group L2 includes an aspherical lens having at least one aspherical surface. This enables favorable correction of spherical aberration, astigmatism, and comatic aberration. Configuring one of the surfaces of a positive lens included in the second lens group L2 as an aspherical surface is more desirable since errors in the surface shape during molding can be reduced. Configuring the lens closest to the image plane in the second lens group L2 or the lens second closest to the image plane to be aspheric is more desirable since off-axis aberrations such as astigmatism and comatic aberration can be favorably corrected.

In the optical system L0 of each example, the third lens group L3 includes a cemented lens consisting of a positive lens and a negative lens. This can favorably correct magnification chromatic aberration and astigmatism.

In the optical system L0 of each example, the aspherical lenses may be made of plastic or other organic materials, or glass materials. A layer of plastic or other organic material with a thickness of approximately 0.01 to 1.00 mm may be molded and cemented or bonded to a spherical glass to form an aspherical lens made of organic material on the spherical glass.

Numerical examples 1 to 7 respectively corresponding to examples 1 to 7 will now be described.

In surface data of each numerical example, r is the radius of curvature, and d the distance between an mth surface and an (m+1)th surface on the optical axis. Here, m is the number of the surface from the light incident side. nd is the refractive index of each optical member on the d-line, and vd the Abbe number of the optical member. The Abbe number vd and partial dispersion ratio θgF of a material are given by:

$$vd = ( Nd - 1 ) / ( NF - NC ) , and$$

$$θ gF = ( Ng - NF ) / ( NF - NC ) ,$$

where Nd, NF, NC, and Ng are the refractive indexes on Fraunhofer d-line (wavelength: 587.6 nm), F-line (wavelength: 486.1 nm), C-line (wavelength: 656.3 nm), and g-line (wavelength: 435.8 nm), respectively.

In each numerical example, d (mm), focal length (mm), F-number, and the half angle of view (°) are all values when the optical system of the example is focused on an object at infinity. A back focus BF is an air-equivalent distance from the final lens surface to the image plane IP. A total optical length is a value obtained by adding the air-equivalent back focus BF to the distance from the first lens surface to the final lens surface. Optical members corresponding to optical filters, faceplates, crystal low-pass filters, and infrared cut filters are excluded.

In each lens, a spherical lens surface is marked with * on the right of the surface number. The aspherical shape is expressed by:

$$x = ( {h}^{2} / R ) / [ 1 + {\{ 1 - ( 1 + k ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12} + A 14 \times {h}^{14} + A 16 \times {h}^{16} ,$$

where x is the amount of displacement from the vertex of the surface in the optical axis direction, h is the height from the optical axis in a direction orthogonal to the optical axis, R is the paraxial radius of curvature, k is the conic constant, and A4, A6, A8, A10, A12,A14, and A16 are aspherical coefficients of the respective orders. “e±XX” in the aspherical coefficients means “×10^{±XX}”.

### Numerical Example 1

unit: mm
Surface data

| Surface number | r | d | nd | νd |
|---|---|---|---|---|
| 1* | 30.434 | 2.50 | 1.58313 | 59.4 |
| 2* | 12.960 | 14.47 | | |
| 3 | −8220.485 | 1.60 | 1.49700 | 81.7 |
| 4 | 48.726 | 5.09 | | |
| 5 | −52.293 | 2.00 | 1.80400 | 46.5 |
| 6* | 61.254 | 0.20 | | |
| 7 | 30.423 | 3.13 | 1.66565 | 35.6 |
| 8 | 60.805 | 4.01 | | |
| 9 | −38.272 | 1.20 | 1.43387 | 95.1 |
| 10 | 89.263 | 0.20 | | |
| 11 | 33.379 | 9.18 | 1.75500 | 52.3 |
| 12 | −25.609 | 1.05 | 1.84666 | 23.8 |
| 13 | −50.774 | 0.20 | | |
| 14 | 121.888 | 4.07 | 1.83481 | 42.7 |
| 15 | −55.780 | 3.62 | | |
| 16 | −26.631 | 1.10 | 1.77047 | 29.7 |
| 17 | −79.426 | 2.00 | | |
| 18 (SP) | ∞ | 2.43 | | |
| 19 | 52.498 | 5.84 | 2.00100 | 29.1 |
| 20 | −45.067 | 1.00 | 1.57060 | 20.1 |
| 21 | −32.493 | 1.10 | 1.66565 | 35.6 |
| 22 | 71.141 | (variable) | | |
| 23 | −120.281 | 7.55 | 1.43875 | 94.7 |
| 24 | −14.562 | 1.00 | 1.77047 | 29.7 |
| 25 | −57.242 | 0.20 | | |
| 26 | 39.251 | 8.64 | 1.49700 | 81.7 |
| 27 | −31.928 | 0.60 | | |
| 28* | 137.086 | 4.68 | 1.85400 | 40.4 |
| 29* | −65.817 | (variable) | | |
| 30 | −1214.157 | 7.51 | 1.59282 | 68.6 |
| 31 | −22.877 | 1.05 | 1.91650 | 31.6 |
| 32 | 331.855 | 14.00 | | |
| Image plane | ∞ | | | |

Aspherical surface data

| Surface number | |
|---|---|
| 1 | K = 0.00000e+00 |
| | A4 = −9.44889e−06 |
| | A6 = −2.78211e−09 |
| | A8 = 1.38292e−11 |
| | A10 = −1.87056e−14 |
| | A12 = 7.67401e−18 |
| 2 | K = −6.82090e−01 |
| | A4 = −2.16920e−06 |
| | A6 = −9.17628e−09 |
| | A8 = −2.33882e−10 |
| | A10 = 8.26939e−13 |
| | A12 = −1.85607e−15 |
| 6 | K = 0.00000e+00 |
| | A4 = 2.29625e−05 |
| | A6 = 1.76297e−08 |
| | A8 = 4.18666e−10 |
| | A10 = −2.45395e−12 |
| | A12 = 6.29348e−15 |
| 28 | K = 0.00000e+00 |
| | A4 = −2.17900e−05 |
| | A6 = −7.22596e−09 |
| | A8 = −1.48661e−10 |
| | A10 = 1.85432e−12 |
| | A12 = −3.03305e−15 |
| 29 | K = 0.00000e+00 |
| | A4 = −1.07831e−05 |
| | A6 = −3.03321e−09 |
| | A8 = −5.03844e−11 |
| | A10 = 1.22127e−12 |
| | A12 = −1.50312e−15 |

Miscellaneous data

| | |
|---|---|
| Focal length | 14.42 |
| F-number | 1.46 |
| Half angle of view | 52.34 |
| Image height | 18.68 |
| Total optical length | 118.50 |
| BF | 14.00 |

| | When focused | When focused at object distance with |
|---|---|---|
| | at infinity | lateral magnification of −0.1 times |
| First surface from | ∞ | 240.532 |
| object plane | | |
| d22 | 5.08 | 4.08 |
| d29 | 2.20 | 3.21 |

Lens group data

| Group | Starting surface | Focal length |
|---|---|---|
| L1 | 1 | 36.30 |
| L2 | 23 | 28.35 |
| L3 | 30 | −57.28 |

Single lens data

| Lens | Starting surface | Focal length | θgF |
|---|---|---|---|
| 1 | 1 | −40.86 | |
| 2 | 3 | −97.46 | |
| 3 | 5 | −34.81 | |
| 4 | 7 | 87.86 | |
| 5 | 9 | −61.56 | |
| 6 | 11 | 20.57 | |
| 7 | 12 | −62.22 | |
| 8 | 14 | 46.32 | |
| 9 | 16 | −52.47 | 0.5951 |
| 10 | 19 | 24.97 | |
| 11 | 20 | 198.38 | 0.7782 |
| 12 | 21 | −33.37 | 0.5824 |
| 13 | 23 | 36.96 | |
| 14 | 24 | −25.61 | 0.5951 |
| 15 | 26 | 36.91 | |
| 16 | 28 | 52.63 | |
| 17 | 30 | 39.24 | |
| 18 | 31 | −23.32 | |

### Numerical Example 2

unit: mm
Surface data

| Surface number | r | d | nd | νd |
|---|---|---|---|---|
| 1 | 52.423 | 1.40 | 1.60311 | 60.6 |
| 2 | 19.691 | 5.03 | | |
| 3 | 29.399 | 2.00 | 1.58313 | 59.4 |
| 4* | 17.890 | 16.43 | | |
| 5 | −23.409 | 1.20 | 1.43875 | 94.7 |
| 6 | −99.819 | 0.50 | | |
| 7 | 167.077 | 8.86 | 1.75500 | 52.3 |
| 8 | −20.287 | 1.05 | 1.85478 | 24.8 |
| 9 | −46.575 | 0.25 | | |
| 10 | 70.946 | 5.42 | 1.90043 | 37.4 |
| 11 | −70.946 | 0.96 | | |
| 12 | 184.489 | 1.10 | 1.54072 | 47.2 |
| 13 | 50.592 | 4.99 | | |
| 14 (SP) | ∞ | 2.18 | | |
| 15 | 124.113 | 3.80 | 2.00069 | 25.5 |
| 16 | −86.925 | 0.70 | 1.57060 | 20.1 |
| 17 | −58.110 | 1.10 | 1.66565 | 35.6 |
| 18 | 92.703 | (variable) | | |
| 19 | −31.832 | 5.02 | 1.49700 | 81.7 |
| 20 | −16.428 | 1.00 | 1.77047 | 29.7 |
| 21 | −103.188 | 0.20 | | |
| 22 | 40.261 | 8.11 | 1.49700 | 81.7 |
| 23 | −34.315 | 2.75 | | |
| 24* | 87.489 | 5.76 | 1.80400 | 46.5 |
| 25* | −54.320 | (variable) | | |
| 26 | 326.711 | 6.95 | 1.59282 | 68.6 |
| 27 | −29.793 | 1.05 | 1.66565 | 35.6 |
| 28 | 59.878 | 18.44 | | |
| Image plane | ∞ | | | |

Aspherical surface data

| Surface number | |
|---|---|
| 4 | K = −4.88704e+00 |
| | A4 = 9.85206e−05 |
| | A6 = −4.60796e−07 |
| | A8 = 2.61477e−09 |
| | A10 = −1.06987e−11 |
| | A12 = 2.62680e−14 |
| | A14 = −2.76184e−17 |
| 24 | K = 0.00000e+00 |
| | A4 = −8.28107e−06 |
| | A6 = 7.81678e−09 |
| | A8 = −5.60781e−11 |
| | A10 = 2.06771e−13 |
| | A12 = −4.03084e−16 |
| 25 | K = 0.00000e+00 |
| | A4 = 6.09726e−06 |
| | A6 = 5.11495e−09 |
| | A8 = −1.22444e−11 |
| | A10 = 1.38078e−13 |
| | A12 = −2.89951e−16 |

Miscellaneous data

| | |
|---|---|
| Focal length | 20.60 |
| F-number | 1.46 |
| Half angle of view | 42.54 |
| Image height | 18.90 |
| Total optical length | 117.50 |
| BF | 18.44 |

| | When focused | When focused at object distance with |
|---|---|---|
| | at infinity | lateral magnification of −0.1 times |
| First surface from | ∞ | 300.024 |
| object plane | | |
| d18 | 9.05 | 7.44 |
| d25 | 2.20 | 3.81 |

Lens group data

| Group | Starting surface | Focal length |
|---|---|---|
| L1 | 1 | 45.15 |
| L2 | 19 | 32.25 |
| L3 | 26 | −85.88 |

Single lens data

| Lens | Starting surface | Focal length | θgF |
|---|---|---|---|
| 1 | 1 | −53.14 | |
| 2 | 3 | −83.73 | |
| 3 | 5 | −70.04 | |
| 4 | 7 | 24.46 | |
| 5 | 8 | −42.84 | 0.6122 |
| 6 | 10 | 40.12 | |
| 7 | 12 | −129.29 | |
| 8 | 15 | 51.55 | |
| 9 | 16 | 304.54 | 0.7782 |
| 10 | 17 | −53.51 | 0.5824 |
| 11 | 19 | 61.63 | |
| 12 | 20 | −25.49 | 0.5951 |
| 13 | 22 | 38.67 | |
| 14 | 24 | 42.45 | |
| 15 | 26 | 46.39 | |
| 16 | 27 | −29.75 | |

### Numerical Example 3

unit: mm
Surface data

| Surface number | r | d | nd | νd |
|---|---|---|---|---|
| 1 | 34.785 | 1.25 | 1.79360 | 37.1 |
| 2 | 17.108 | 5.10 | | |
| 3 | 29.757 | 2.00 | 1.53500 | 56.0 |
| 4* | 19.213 | 10.91 | | |
| 5 | −21.843 | 1.20 | 1.49700 | 81.7 |
| 6 | −59.460 | 0.38 | | |
| 7 | 108.499 | 9.23 | 1.72916 | 54.7 |
| 8 | −17.093 | 1.00 | 1.85478 | 24.8 |
| 9 | −37.633 | 0.20 | | |
| 10 | 40.930 | 4.97 | 2.00100 | 29.1 |
| 11 | −42.422 | 1.00 | 1.57501 | 41.5 |
| 12 | 30.464 | 5.24 | | |
| 13 (SP) | ∞ | 2.53 | | |
| 14 | 83.477 | 1.85 | 2.00100 | 29.1 |
| 15 | 595.325 | (variable) | | |
| 16 | −22.125 | 4.05 | 1.49700 | 81.7 |
| 17 | −11.634 | 0.90 | 1.77047 | 29.7 |
| 18 | −78.451 | 0.20 | | |
| 19 | 72.244 | 6.30 | 1.72916 | 54.7 |
| 20 | −22.067 | 0.20 | | |
| 21* | −169.027 | 4.15 | 1.53500 | 56.0 |
| 22* | −27.901 | (variable) | | |
| 23 | −131.373 | 8.10 | 1.59282 | 68.6 |
| 24 | −17.133 | 1.05 | 1.65412 | 39.7 |
| 25 | 111.091 | 17.25 | | |
| Image plane | ∞ | | | |

Aspherical surface data

| Surface number | |
|---|---|
| 4 | K = 0.00000e+00 |
| | A4 = −6.65980e−06 |
| | A6 = −3.24494e−08 |
| | A8 = 5.25976e−11 |
| | A10 = −5.17248e−13 |
| 21 | K = 0.00000e+00 |
| | A4 = −3.01742e−05 |
| | A6 = 1.03918e−08 |
| | A8 = −2.78416e−10 |
| | A10 = 2.38934e−12 |
| | A12 = −1.19202e−14 |
| 22 | K = 0.00000e+00 |
| | A4 = 6.71096e−06 |
| | A6 = 2.88119e−08 |
| | A8 = −2.08523e−10 |
| | A10 = 2.35578e−12 |
| | A12 = −9.87781e−15 |

Miscellaneous data

| | |
|---|---|
| Focal length | 20.60 |
| F-number | 1.85 |
| Half angle of view | 42.64 |
| Image height | 18.97 |
| Total optical length | 98.50 |
| BF | 17.25 |

| | When focused | When focused at object distance with |
|---|---|---|
| | at infinity | lateral magnification of −0.1 times |
| First surface from | ∞ | 283.670 |
| object plane | | |
| d15 | 7.24 | 5.62 |
| d22 | 2.20 | 3.81 |

Lens group data

| Group | Starting surface | Focal length |
|---|---|---|
| L1 | 1 | 33.12 |
| L2 | 16 | 31.34 |
| L3 | 23 | −70.29 |

Single lens data

| Lens | Starting surface | Focal length | θgF |
|---|---|---|---|
| 1 | 1 | −43.79 | |
| 2 | 3 | −108.52 | |
| 3 | 5 | −70.21 | |
| 4 | 7 | 20.90 | |
| 5 | 8 | −37.48 | 0.6122 |
| 6 | 10 | 21.45 | |
| 7 | 11 | −30.68 | |
| 8 | 14 | 96.82 | |
| 9 | 16 | 43.76 | |
| 10 | 17 | −17.83 | 0.5951 |
| 11 | 19 | 23.85 | |
| 12 | 21 | 61.83 | |
| 13 | 23 | 32.38 | |
| 14 | 24 | −22.62 | |

### Numerical Example 4

unit: mm
Surface data

| Surface number | r | d | nd | νd | θgF |
|---|---|---|---|---|---|
| 1 | 71.542 | 1.05 | 1.62004 | 36.3 | |
| 2 | 20.538 | 9.22 | | | |
| 3 | 536.237 | 1.80 | 1.53500 | 56.0 | |
| 4* | 195.727 | 6.51 | | | |
| 5 | −25.880 | 1.00 | 1.58144 | 40.8 | |
| 6 | −45.968 | 0.23 | | | |
| 7 | −81.956 | 9.01 | 1.87070 | 40.7 | |
| 8 | −20.977 | 1.05 | 1.85478 | 24.8 | |
| 9 | −41.688 | 1.33 | 0.6122 | | |
| 10 | 35.061 | 4.85 | 2.00069 | 25.5 | |
| 11 | 788.676 | 0.99 | 0.7230 | | |
| 12 | 29.284 | 1.10 | 1.51742 | 52.4 | 0.6122 |
| 13 | 19.707 | 11.37 | | | |
| 14 | −30.397 | 4.97 | 1.59282 | 68.6 | |
| 15 | −16.310 | 1.00 | 1.85478 | 24.8 | |
| 16 | −23.209 | 0.50 | | | |
| 17 (SP) | ∞ | (variable) | | | |
| 18 | −23.769 | 3.97 | 1.49700 | 81.7 | |
| 19 | −15.307 | 0.70 | 1.60401 | 20.8 | |
| 20 | −14.297 | 1.00 | 1.85478 | 24.8 | |
| 21 | −46.845 | 0.20 | | | |
| 22 | 66.641 | 9.32 | 1.49700 | 81.7 | |
| 23 | −27.000 | 0.15 | | | |
| 24* | 119.785 | 6.50 | 1.80400 | 46.5 | |
| 25* | −47.701 | (variable) | | | |
| 26 | 57.367 | 4.83 | 1.92286 | 20.9 | |
| 27 | −215.059 | 1.05 | 1.77047 | 29.7 | |
| 28 | 35.159 | 6.22 | | | |
| 29 | −64.493 | 1.00 | 1.77047 | 29.7 | |
| 30 | −11124.715 | 12.50 | | | |
| Image plane | ∞ | | | | |

Aspherical surface data

| Surface number | |
|---|---|
| 4 | K = 0.00000e+00 |
| | A4 = −7.78923e−07 |
| | A6 = −4.74554e−09 |
| | A8 = −3.40498e−12 |
| 24 | K = 0.00000e+00 |
| | A4 = −5.94169e−06 |
| | A6 = 1.89102e−08 |
| | A8 = −1.30969e−10 |
| | A10 = 5.43367e−13 |
| | A12 = −9.16322e−16 |
| 25 | K = 0.00000e+00 |
| | A4 = 4.36873e−06 |
| | A6 = 1.94417e−08 |
| | A8 = −1.21992e−10 |
| | A10 = 5.31778e−13 |
| | A12 = −8.61502e−16 |

Miscellaneous data

| | |
|---|---|
| Focal length | 24.00 |
| F-number | 1.50 |
| Half angle of view | 38.29 |
| Image height | 18.95 |
| Total optical length | 113.00 |
| BF | 12.50 |

| | When focused | When focused at object distance with |
|---|---|---|
| | at infinity | lateral magnification of −0.1 times |
| First surface from | ∞ | 325.872 |
| object plane | | |
| d17 | 7.40 | 5.34 |
| d25 | 2.20 | 4.25 |

Lens group data

| Group | Starting surface | Focal length |
|---|---|---|
| L1 | 1 | 47.04 |
| L2 | 18 | 31.80 |
| L3 | 26 | −64.02 |

Single lens data

| Lens | Starting surface | Focal length | θgF |
|---|---|---|---|
| 1 | 1 | −46.83 | |
| 2 | 3 | −577.20 | |
| 3 | 5 | −103.75 | |
| 4 | 7 | 30.30 | |
| 5 | 8 | −50.58 | |
| 6 | 10 | 36.55 | |
| 7 | 12 | −121.22 | |
| 8 | 14 | 52.48 | |
| 9 | 15 | −68.79 | 0.6122 |
| 10 | 18 | 74.86 | |
| 11 | 19 | 284.54 | 0.7230 |
| 12 | 20 | −24.42 | 0.6122 |
| 13 | 22 | 39.98 | |
| 14 | 24 | 43.18 | |
| 15 | 26 | 49.49 | |
| 16 | 27 | −39.15 | |
| 17 | 29 | −84.20 | |

### Numerical Example 5

unit: mm
Surface data

| Surface number | r | d | nd | νd |
|---|---|---|---|---|
| 1* | 31.090 | 2.50 | 1.58313 | 59.4 |
| 2* | 13.099 | 14.59 | | |
| 3 | −530.553 | 1.70 | 1.49700 | 81.7 |
| 4 | 47.214 | 5.63 | | |
| 5 | −49.986 | 2.00 | 1.80400 | 46.5 |
| 6* | 87.783 | 0.20 | | |
| 7 | 31.641 | 3.06 | 1.66565 | 35.6 |
| 8 | 68.370 | 3.74 | | |
| 9 | −36.085 | 1.20 | 1.43387 | 95.1 |
| 10 | 60.775 | 0.20 | | |
| 11 | 32.009 | 8.73 | 1.75500 | 52.3 |
| 12 | −25.657 | 1.05 | 1.84666 | 23.8 |
| 13 | −54.614 | 0.20 | | |
| 14 | 167.133 | 3.92 | 1.83481 | 42.7 |
| 15 | −53.249 | 4.34 | | |
| 16 | −24.473 | 1.10 | 1.77047 | 29.7 |
| 17 | −65.694 | 2.00 | | |
| 18 (SP) | ∞ | 1.68 | | |
| 19 | 50.345 | 6.13 | 2.00100 | 29.1 |
| 20 | −44.102 | 1.00 | 1.57060 | 20.1 |
| 21 | −32.378 | 1.10 | 1.66565 | 35.6 |
| 22 | 87.176 | (variable) | | |
| 23 | −140.226 | 7.75 | 1.43875 | 94.7 |
| 24 | −14.948 | 1.00 | 1.77047 | 29.7 |
| 25 | −65.160 | 0.20 | | |
| 26 | 40.856 | 8.72 | 1.49700 | 81.7 |
| 27 | −31.383 | 0.20 | | |
| 28* | 128.494 | 4.66 | 1.85400 | 40.4 |
| 29* | −70.134 | (variable) | | |
| 30 | −319.132 | 7.26 | 1.59282 | 68.6 |
| 31 | −23.023 | 1.05 | 1.91650 | 31.6 |
| 32 | −1191.612 | 15.50 | | |
| Image plane | ∞ | | | |

Aspherical surface data

| Surface number | |
|---|---|
| 1 | K = 0.00000e+00 |
| | A4 = −1.01110e−05 |
| | A6 = 8.17661e−10 |
| | A8 = 8.93040e−12 |
| | A10 = −1.54052e−14 |
| | A12 = 7.63241e−18 |
| 2 | K = −6.44184e−01 |
| | A4 = −6.39936e−06 |
| | A6 = −1.43284e−08 |
| | A8 = −2.16244e−10 |
| | A10 = 7.31957e−13 |
| | A12 = −1.78412e−15 |
| 6 | K = 0.00000e+00 |
| | A4 = 2.13738e−05 |
| | A6 = 2.10113e−08 |
| | A8 = 3.60161e−10 |
| | A10 = −2.14645e−12 |
| | A12 = 6.19796e−15 |
| 28 | K = 0.00000e+00 |
| | A4 = −2.11705e−05 |
| | A6 = −5.23668e−09 |
| | A8 = −1.83281e−10 |
| | A10 = 1.81505e−12 |
| | A12 = −2.71601e−15 |
| 29 | K = 0.00000e+00 |
| | A4 = −1.02347e−05 |
| | A6 = −7.27343e−09 |
| | A8 = −3.83789e−11 |
| | A10 = 1.01331e−12 |
| | A12 = −1.00325e−15 |

Miscellaneous data

| | |
|---|---|
| Focal length | 14.42 |
| F-number | 1.46 |
| Half angle of view | 52.34 |
| Image height | 18.68 |
| Total optical length | 119.50 |
| BF | 15.50 |

| | When focused | When focused at object distance with |
|---|---|---|
| | at infinity | lateral magnification of −0.1 times |
| First surface from | ∞ | 241.623 |
| object plane | | |
| d22 | 4.90 | 3.89 |
| d29 | 2.20 | 3.21 |

Lens group data

| Group | Starting surface | Focal length |
|---|---|---|
| L1 | 1 | 36.74 |
| L2 | 23 | 29.10 |
| L3 | 30 | −65.56 |

Single lens data

| Lens | Starting surface | Focal length | θgF |
|---|---|---|---|
| 1 | 1 | −40.91 | |
| 2 | 3 | −87.15 | |
| 3 | 5 | −39.36 | |
| 4 | 7 | 85.64 | |
| 5 | 9 | −51.99 | |
| 6 | 11 | 20.18 | |
| 7 | 12 | −58.12 | |
| 8 | 14 | 48.77 | |
| 9 | 16 | −51.22 | 0.5951 |
| 10 | 19 | 24.27 | |
| 11 | 20 | 207.03 | 0.7782 |
| 12 | 21 | −35.34 | 0.5824 |
| 13 | 23 | 37.43 | |
| 14 | 24 | −25.40 | 0.5951 |
| 15 | 26 | 37.20 | |
| 16 | 28 | 53.71 | |
| 17 | 30 | 41.48 | |
| 18 | 31 | −25.63 | |

### Numerical Example 6

unit: mm
Surface data

| Surface number | r | d | nd | νd |
|---|---|---|---|---|
| 1 | 43.024 | 1.40 | 1.61800 | 63.4 |
| 2 | 20.105 | 5.66 | | |
| 3 | 32.408 | 2.00 | 1.58313 | 59.4 |
| 4* | 17.039 | 15.89 | | |
| 5 | −23.276 | 1.20 | 1.43875 | 94.7 |
| 6 | −65.876 | 0.50 | | |
| 7 | 1040.783 | 9.43 | 1.75500 | 52.3 |
| 8 | −20.743 | 1.05 | 1.85478 | 24.8 |
| 9 | −51.168 | 0.25 | | |
| 10 | 88.793 | 5.21 | 1.88100 | 40.1 |
| 11 | −61.610 | 0.25 | | |
| 12 | 53.033 | 1.10 | 1.48749 | 70.2 |
| 13 | 33.098 | 6.53 | | |
| 14 (SP) | ∞ | 1.38 | | |
| 15 | 56.211 | 4.07 | 2.00069 | 25.5 |
| 16 | −282.390 | 0.70 | 1.57060 | 20.1 |
| 17 | −106.816 | 1.10 | 1.61340 | 44.3 |
| 18 | 35.085 | (variable) | | |
| 19 | −55.827 | 6.01 | 1.49700 | 81.7 |
| 20 | −17.101 | 1.00 | 1.77047 | 29.7 |
| 21 | −285.670 | 0.20 | | |
| 22 | 49.100 | 7.70 | 1.49700 | 81.7 |
| 23 | −32.916 | 4.78 | | |
| 24* | 167.193 | 5.11 | 1.80400 | 46.5 |
| 25* | −71.686 | (variable) | | |
| 26 | 64.441 | 8.97 | 1.59282 | 68.6 |
| 27 | −37.571 | 1.05 | 1.66565 | 35.6 |
| 28 | 96.827 | 20.51 | | |
| Image plane | ∞ | | | |

Aspherical surface data

| Surface number | |
|---|---|
| 4 | K = −4.93669e+00 |
| | A4 = 1.15091e−04 |
| | A6 = −5.84829e−07 |
| | A8 = 3.36673e−09 |
| | A10 = −1.32319e−11 |
| | A12 = 2.98902e−14 |
| | A14 = −2.80832e−17 |
| 24 | K = 0.00000e+00 |
| | A4 = −3.47747e−06 |
| | A6 = −1.65912e−09 |
| | A8 = 4.12770e−11 |
| | A10 = −9.38830e−14 |
| | A12 = −2.12904e−17 |
| 25 | K = 0.00000e+00 |
| | A4 = 3.21233e−06 |
| | A6 = 1.28708e−09 |
| | A8 = 3.52617e−11 |
| | A10 = −2.24322e−14 |
| | A12 = −1.03425e−16 |

Miscellaneous data

| | |
|---|---|
| Focal length | 20.60 |
| F-number | 1.50 |
| Half angle of view | 42.57 |
| Image height | 18.93 |
| Total optical length | 125.00 |
| BF | 20.51 |

| | When focused | When focused at object distance with |
|---|---|---|
| | at infinity | lateral magnification of −0.1 times |
| First surface from | ∞ | 309.542 |
| object plane | | |
| d18 | 9.74 | 7.07 |
| d25 | 2.20 | 4.88 |

Lens group data

| Group | Starting surface | Focal length |
|---|---|---|
| L1 | 1 | 63.61 |
| L2 | 19 | 45.28 |
| L3 | 26 | 1142.84 |

Single lens data

| Lens | Starting surface | Focal length | θgF |
|---|---|---|---|
| 1 | 1 | −62.53 | |
| 2 | 3 | −64.71 | |
| 3 | 5 | −82.75 | |
| 4 | 7 | 27.04 | |
| 5 | 8 | −41.47 | 0.6122 |
| 6 | 10 | 41.97 | |
| 7 | 12 | −183.95 | |
| 8 | 15 | 47.13 | |
| 9 | 16 | 300.65 | 0.7782 |
| 10 | 17 | −42.93 | 0.5633 |
| 11 | 19 | 47.17 | |
| 12 | 20 | −23.65 | 0.5951 |
| 13 | 22 | 40.93 | |
| 14 | 24 | 63.00 | |
| 15 | 26 | 41.39 | |
| 16 | 27 | −40.54 | |

### Numerical Example 7

unit: mm
Surface data

| Surface number | r | d | nd | νd | θgF |
|---|---|---|---|---|---|
| 1 | 41.398 | 1.25 | 1.85026 | 32.3 | |
| 2 | 16.925 | 7.52 | | | |
| 3 | 62.508 | 2.00 | 1.53500 | 56.0 | |
| 4* | 39.199 | 8.09 | | | |
| 5 | −20.954 | 1.20 | 1.49700 | 81.7 | 0.6122 |
| 6 | −34.367 | 0.20 | | | |
| 7 | 1150.801 | 8.11 | 1.87070 | 40.7 | |
| 8 | −18.645 | 1.00 | 1.85478 | 24.8 | |
| 9 | −53.827 | 0.20 | | | |
| 10 | 25.911 | 4.47 | 1.95375 | 32.3 | 0.5951 |
| 11 | −857.774 | 0.63 | | | |
| 12 | −1141.763 | 1.00 | 1.51742 | 52.4 | |
| 13 | 19.319 | 6.01 | | | |
| 14 (SP) | ∞ | 2.55 | | | |
| 15 | 86.000 | 1.99 | 2.00100 | 29.1 | |
| 16 | ∞ | (variable) | | | |
| 17 | −23.457 | 4.27 | 1.49700 | 81.7 | |
| 18 | −11.526 | 0.90 | 1.77047 | 29.7 | |
| 19 | −46.802 | 0.20 | | | |
| 20 | 53.297 | 7.13 | 1.59282 | 68.6 | |
| 21 | −22.514 | 1.46 | | | |
| 22* | −204.835 | 4.59 | 1.80400 | 46.5 | |
| 23* | −34.800 | (variable) | | | |
| 24 | −959.581 | 6.27 | 1.59282 | 68.6 | |
| 25 | −23.602 | 1.05 | 1.66565 | 35.6 | |
| 26 | 52.918 | 17.22 | | | |
| Image plane | ∞ | | | | |

Aspherical surface data

| Surface number | |
|---|---|
| 4 | K = 0.00000e+00 |
| | A4 = −8.84221e−06 |
| | A6 = −2.21367e−08 |
| | A8 = −3.29970e−11 |
| | A10 = −5.08866e−14 |
| 22 | K = 0.00000e+00 |
| | A4 = −2.21360e−05 |
| | A6 = 1.50179e−08 |
| | A8 = −4.23029e−10 |
| | A10 = 3.18520e−12 |
| | A12 = −1.12092e−14 |
| 23 | K = 0.00000e+00 |
| | A4 = 1.34397e−06 |
| | A6 = 2.33770e−08 |
| | A8 = −2.84542e−10 |
| | A10 = 2.23920e−12 |
| | A12 = −7.01230e−15 |

Miscellaneous data

| | |
|---|---|
| Zoom ratio | 1.00 |
| Focal length | 20.44 |
| F-number | 1.85 |
| Half angle of view | 42.77 |
| Image height | 18.91 |
| Total optical length | 98.17 |
| BF | 17.22 |

| | When focused | When focused at object distance with |
|---|---|---|
| | at infinity | lateral magnification of −0.1 times |
| First surface from | ∞ | 282.639 |
| object plane | | |
| d16 | 6.65 | 5.21 |
| d23 | 2.20 | 3.64 |

Lens group data

| Group | Starting surface | Focal length |
|---|---|---|
| L1 | 1 | 39.40 |
| L2 | 17 | 28.11 |
| L3 | 24 | −61.16 |

Single lens data

| Lens | Starting surface | Focal length |
|---|---|---|
| 1 | 1 | −34.48 |
| 2 | 3 | −202.55 |
| 3 | 5 | −111.34 |
| 4 | 7 | 21.14 |
| 5 | 8 | −33.82 |
| 6 | 10 | 26.44 |
| 7 | 12 | −36.71 |
| 8 | 15 | 85.88 |
| 9 | 17 | 40.75 |
| 10 | 18 | −20.07 |
| 11 | 20 | 27.67 |
| 12 | 22 | 51.52 |
| 13 | 24 | 40.72 |
| 14 | 25 | −24.39 |

The following Tables 1 and 2 summarize various values of the numerical examples.

TABLE 1

| | | Example 1 | Example 2 | Example 3 | Example 4 | Example 5 | Example 6 | Example 7 |
|---|---|---|---|---|---|---|---|---|
| f | | 14.420 | 20.600 | 20.600 | 24.000 | 14.420 | 20.600 | 20.438 |
| f₁ | | 36.300 | 45.150 | 33.117 | 47.045 | 36.741 | 63.607 | 39.396 |
| f₂ | | 28.349 | 32.252 | 31.337 | 31.801 | 29.104 | 45.280 | 28.109 |
| f₃ | | −57.275 | −85.884 | −70.294 | −64.019 | −65.560 | 1142.838 | −61.162 |
| β₂ | | 0.317 | 0.378 | 0.488 | 0.433 | 0.313 | 0.350 | 0.403 |
| β₃ | | 1.255 | 1.207 | 1.274 | 1.179 | 1.254 | 0.926 | 1.286 |
| L | | 118.500 | 117.502 | 98.501 | 113.000 | 119.500 | 125.000 | 98.166 |
| M₂ | | −1.005 | −1.614 | −1.615 | −2.054 | −1.005 | −2.677 | −1.439 |
| DSP | | 48.880 | 49.884 | 38.768 | 44.536 | 47.842 | 54.021 | 39.250 |
| sk | | 14.000 | 18.438 | 17.253 | 12.500 | 15.500 | 20.515 | 17.224 |
| ΣDair | | 40.301 | 44.537 | 34.190 | 46.306 | 40.075 | 47.381 | 35.715 |
| R₂₁ | | −120.2812 | −31.832 | −22.125 | −23.76945 | −140.2257 | −55.827 | −23.457 |
| R₂₂ | | −65.8172 | −54.31954 | −27.90084 | −47.70056 | −70.13407 | −71.68556 | −34.8000 |
| Conditional | f₂/f | 1.966 | 1.566 | 1.521 | 1.325 | 2.018 | 2.198 | 1.375 |
| expression | | | | | | | | |
| (1) | | | | | | | | |
| Conditional | sk/f | 0.971 | 0.895 | 0.838 | 0.521 | 1.075 | 0.996 | 0.843 |
| expression | | | | | | | | |
| (2) | | | | | | | | |
| Conditional | f₁/f₂ | 1.280 | 1.400 | 1.057 | 1.479 | 1.262 | 1.405 | 1.402 |
| expression | | | | | | | | |
| (3) | | | | | | | | |
| Conditional | f/f₃ | −0.252 | −0.240 | −0.293 | −0.375 | −0.220 | 0.018 | −0.334 |
| expression | | | | | | | | |
| (4) | | | | | | | | |
| Conditional | (R₂₂ − | −0.293 | 0.261 | 0.115 | 0.335 | −0.333 | 0.124 | 0.195 |
| expression | R₂₁)/ | | | | | | | |
| (5) | (R₂₂ + | | | | | | | |
| | R₂₁) | | | | | | | |
| Conditional | (1 − | 1.417 | 1.249 | 1.235 | 1.130 | 1.418 | 0.752 | 1.386 |
| expression | β₂²) * | | | | | | | |
| (8) | β₃² | | | | | | | |
| Conditional | sk/\|f₃\| | 0.244 | 0.215 | 0.245 | 0.195 | 0.236 | 0.018 | 0.282 |
| expression | | | | | | | | |
| (9) | | | | | | | | |
| Conditional | Σdair/ | 0.386 | 0.450 | 0.421 | 0.461 | 0.385 | 0.453 | 0.441 |
| expression | (L − | | | | | | | |
| (10) | sk) | | | | | | | |
| Conditional | L/f | 8.218 | 5.704 | 4.782 | 4.708 | 8.287 | 6.068 | 4.803 |
| expression | | | | | | | | |
| (11) | | | | | | | | |
| Conditional | M₂/DSP | −0.021 | −0.032 | −0.042 | −0.046 | −0.021 | −0.050 | −0.037 |
| expression | | | | | | | | |
| (13) | | | | | | | | |
| Conditional | (DSP + | 0.531 | 0.581 | 0.569 | 0.505 | 0.530 | 0.596 | 0.575 |
| expression | sk)/L | | | | | | | |
| (16) | | | | | | | | |
| Conditional | f₁/f | 2.517 | 2.192 | 1.608 | 1.960 | 2.548 | 3.088 | 1.928 |
| expression | | | | | | | | |
| (17) | | | | | | | | |

Lenses satisfying conditional expressions (6), (7), (12), (14), and (15) in the numerical examples and various numerical values thereof are summarized in the following Table 2.

TABLE 2

| | Example 1 | | Example 2 | | Example 3 | | Example 4 | | Example 5 | | Example 6 | | Example 7 | |
|---|---|---|---|---|---|---|---|---|---|---|---|---|---|---|
| νd₁n | G2 | 81.65 | G3 | 94.66 | G3 | 81.65 | | | G2 | 81.65 | G3 | 94.66 | G3 | 81.65 |
| Conditional | G5 | 95.10 | | | | | | | G5 | 95.10 | | | | |
| expression | | | | | | | | | | | | | | |
| (14) | | | | | | | | | | | | | | |
| νd₂p | G13 | 94.66 | G11 | 81.65 | G9 | 81.65 | G8 | 68.62 | G13 | 94.66 | G11 | 81.65 | G9 | 81.65 |
| Conditional | G15 | 81.65 | G13 | 81.65 | | | G10 | 81.65 | G15 | 81.65 | G13 | 81.65 | G11 | 68.62 |
| expression | | | | | | | G13 | 81.65 | | | | | | |
| (12) | | | | | | | | | | | | | | |
| Ndn | G9 | 1.77047 | G5 | 1.85478 | G5 | 1.85478 | G9 | 1.85478 | G9 | 1.77047 | G5 | 1.85478 | G5 | 1.85478 |
| | G12 | 1.66565 | G10 | 1.66565 | G10 | 1.77047 | G12 | 1.85478 | G12 | 1.66565 | G10 | 1.61340 | G10 | 1.77047 |
| | G14 | 1.77047 | G12 | 1.77047 | | | | | G14 | 1.77047 | G12 | 1.77047 | | |
| νdn | G9 | 29.74 | G5 | 24.80 | G5 | 24.80 | G9 | 24.80 | G9 | 29.74 | G5 | 24.80 | G5 | 24.80 |
| | G12 | 35.64 | G10 | 35.64 | G10 | 29.74 | G12 | 24.80 | G12 | 35.64 | G10 | 44.27 | G10 | 29.74 |
| | G14 | 29.74 | G12 | 29.74 | | | | | G14 | 29.74 | G12 | 29.74 | | |
| θgFn | G9 | 0.5951 | G5 | 0.6122 | G5 | 0.6122 | G9 | 0.6122 | G9 | 0.5951 | G5 | 0.6122 | G5 | 0.6122 |
| | G12 | 0.5824 | G10 | 0.5824 | G10 | 0.5951 | G12 | 0.6122 | G12 | 0.5821 | G10 | 0.5633 | G10 | 0.5951 |
| | G14 | 0.5951 | G12 | 0.5951 | | | | | G14 | 0.5951 | G12 | 0.5951 | | |
| νdp | G11 | 20.08 | G9 | 20.08 | | | G11 | 20.81 | G11 | 20.08 | G9 | 20.08 | | |
| θgFp | G11 | 0.7782 | G9 | 0.7782 | | | G11 | 0.7230 | G11 | 0.7782 | G9 | 0.7782 | | |
| Conditional | G9 | −0.0047 | G5 | 0.0000 | G5 | 0.0000 | G9 | 0.0000 | G9 | −0.0047 | G5 | 0.0000 | G5 | 0.0000 |
| expression | G12 | −0.0025 | G10 | −0.0025 | G10 | −0.0047 | G12 | 0.0000 | G12 | −0.0025 | G10 | 0.0000 | G10 | −0.0047 |
| (6) | G14 | −0.0047 | G12 | −0.0047 | | | | | G14 | −0.0047 | G12 | −0.0047 | | |
| Conditional | G9 | −0.08434 | G5 | −0.07182 | G5 | −0.07182 | G9 | −0.07182 | G9 | −0.08434 | G5 | −0.07182 | G5 | −0.07182 |
| expression | G12 | −0.10331 | G10 | −0.10331 | G10 | −0.08434 | G12 | −0.07182 | G12 | −0.10331 | G10 | −0.03006 | G10 | −0.08434 |
| (7) | G14 | −0.08434 | G12 | −0.08434 | | | | | G14 | −0.08434 | G12 | −0.08434 | | |
| Conditional | G11 | 0.14427 | G9 | 0.14427 | | | G11 | 0.09177 | G11 | 0.14427 | G9 | 0.14427 | | |
| expression | | | | | | | | | | | | | | |
| (15) | | | | | | | | | | | | | | |

### Imaging Apparatus

Next, an example of an imaging apparatus including the optical system L0 according to the present exemplary embodiment will be described.

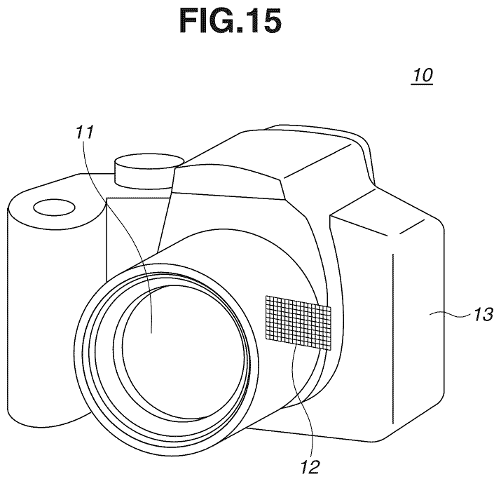

FIG. 15 is a schematic diagram illustrating an imaging apparatus 10 including the optical system L0 according to the present exemplary embodiment. The imaging apparatus 10 includes a camera main body 13, an optical system 11 similar to one of the foregoing examples 1 to 7, and a light receiving element 12 that photoelectrically converts an image formed by the optical system 11.

The imaging apparatus 10 of this example can obtain high-quality images formed by the optical system 11 that has a wide angle with improved distortion aberration correction and marginal illumination ratio.

An image sensor such as CCD and CMOS sensors can be used as the light receiving element 12. Various aberrations of the image obtained by the light receiving element 12, such as distortion aberration and chromatic aberration, can be corrected using electrical techniques, for example, whereby the output image quality can be enhanced.

The optical systems L0 of the foregoing examples are not limited to the digital camera illustrated in FIG. 15, and can be applied to various optical devices such as a silver halide film camera, a video camera, and a telescope. Both integral lens cameras and interchangeable lens cameras are applicable.

### Lens Apparatus

Next, an example of a lens apparatus including the optical system L0 according to the present exemplary embodiment will be described.

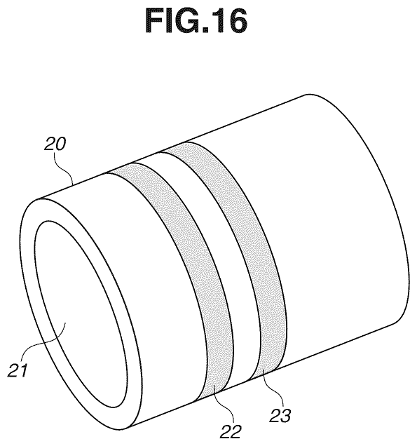

FIG. 16 is a schematic external view of the lens apparatus including the optical system L0 according to the present exemplary embodiment. The lens apparatus of FIG. 16 is an interchangeable lens that can be detachably attached to a not-illustrated camera main body.

A lens apparatus 20 includes an imaging optical system 21 similar to one of the foregoing examples 1 to 7. The lens apparatus 20 includes a focus operation unit 22 and an operation unit 23 for changing an imaging mode.

When the user operates the focus operation unit 22, the arrangement of the imaging optical system 21 is mechanically or electrically changed to change the focus position. When the user operates the operation unit 23, the arrangement of the lens groups in the imaging optical system 21 may be changed for purposes other than focusing. For example, based on operation of the operation unit 23, the arrangement of the lens groups in the imaging optical system 21 may be mechanically or electrically changed to change aberrations of the imaging optical system 21. In doing so, the focus position remains substantially unchanged.

The exemplary embodiment and examples of the disclosure have been described above. The disclosure is not limited to the foregoing exemplary embodiment and examples, and various combinations, changes, and modifications can be made without departing from the gist thereof.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-101168, filed Jun. 24, 2024, which is hereby incorporated by reference herein in its entirety.

What is claimed is:

1. An optical system comprising:
a first lens group having positive refractive power;
a second lens group having positive refractive power; and
a third lens group,
the first, second, and third lens groups being arranged in order from an object side to an image side,
wherein the second lens group is configured to move relative to an image plane in an optical axis direction during focusing, and the first and third lens groups are configured to remain stationary with respect to the image plane during focusing,
wherein the first lens group includes three negative lenses that are consecutively arranged in the optical axis direction and located closest to an object plane,
wherein the second lens group includes two or more lenses, and
wherein the following conditional expressions are satisfied:
$$\begin{matrix}0.5 < f 2 / f < 3. , \\ 0.2 < sk / f \leq 1.075 , and \\ 0. < sk / \vert f 3 \vert < 0.8 ,\end{matrix}$$
where f is a focal length of the entire optical system, sk is an air-equivalent back focus in a case where the optical system is focused at infinity, f2 is a focal length of the second lens group, and f3 is a focal length of the third lens group.

2. The optical system according to claim 1, wherein the following conditional expression is satisfied:
$$4. < L / f < 15.$$
where L is a total optical length of the optical system.

3. The optical system according to claim 1, wherein the following conditional expression is satisfied:
$$0.3 < f 1 / f 2 < 3. ,$$
where f1 is a focal length of the first lens group.

4. The optical system according to claim 1, wherein the following conditional expression is satisfied:
$$- 1.5 < f / f 3 < 1.5 ,$$
where f3 is the focal length of the third lens group.

5. The optical system according to claim 1, wherein the second lens group includes at least two positive lenses and at least one negative lens.

6. The optical system according to claim 1,
wherein a lens located closest to the object plane in the second lens group has a concave object-side lens surface,
wherein a lens located closest to the image plane in the second lens group has a convex image-side lens surface, and
wherein the following conditional expression is satisfied:
$$- 1.5 < ( R 22 - R 21 ) / ( R 22 + R 21 ) < 1.5 ,$$
where R21 is a radius of curvature of the object-side lens surface of the lens located closest to the object plane in the second lens group, and R22 is a radius of curvature of the image-side lens surface of the lens located closest to the image plane in the second lens group.

7. The optical system according to claim 1,
wherein at least one of the first lens group and the second lens group includes a negative lens Gn, and
wherein the following conditional expressions are satisfied:
$$\begin{matrix}- 0.015 < Δθ gFn < 0.015 , and \\ - 0.2 < Ndn - ( - 0.0145425 \times vdn + 2.28725 ) < 0.05 , \\ where \\ Δ θ gFn = θ gFn - ( - 0.0025116 \times vdn + 0.67449 ) ,\end{matrix}$$
and
where Ndn is a refractive index of material of the negative lens Gn on d-line, vdn is an Abbe number, θgFn is a partial dispersion ratio on g-and F-lines, and ΔθgFn is an anomalous partial dispersion.

8. The optical system according to claim 7, wherein the first lens group includes the at least one negative lens Gn.

9. The optical system according to claim 7, wherein the second lens group includes the at least one negative lens Gn.

10. The optical system according to claim 1, wherein the following conditional expression is satisfied:
$$0.5 < ( 1 - β {2}^{2} ) \times β {3}^{2} < 2.5 ,$$
where β2 is a lateral magnification of the second lens group in the case where the optical system is focused at infinity, and β3 is a lateral magnification of the third lens group in the case where the optical system is focused at infinity.

11. The optical system according to claim 1, further comprising an aperture stop located inside the first lens group or next to an image side of the first lens group,
wherein the aperture stop is configured to remain stationary with respect to the image plane in the optical direction during focusing.

12. The optical system according to claim 1, wherein the following conditional expression is satisfied:
$$0.2 < Σ Dair / ( L - sk ) < 0.7 ,$$
where ΣDair is a summation of air gaps on an optical axis from an object-side lens surface of a lens located closest to the object plane in the first lens group to an image-side lens surface of a lens located closest to the image plane in the third lens group, and L is a total optical length of the optical system.

13. The optical system according to claim 1,
wherein the second lens group includes at least one positive lens G2p, and
wherein the following conditional expression is satisfied:
$$60. < vd 2 p < 100. ,$$
where vd2p is an Abbe number of material of the positive lens G2p.

14. The optical system according to claim 1, wherein the following conditional expression is satisfied:
$$- 0.2 < M 2 / DPS < - 0.005 ,$$
where M2 is an amount of movement of the second lens group during focusing from infinity to an object distance where a lateral magnification of the entire optical system is −0.1 times, a sign of the amount of movement is positive in a case where the second lens group moves to the image side during focusing from infinity to the object distance where the lateral magnification of the entire optical system is −0.1 times, and DSP is a distance on an optical axis from an aperture stop to a lens surface closest to the image plane in the optical system in the case where the optical system is focused at infinity.

15. The optical system according to claim 1,
wherein the first lens group includes a negative lens G1n, and
wherein the following conditional expression is satisfied:
$$60. < vd 1 n < 100. ,$$
where vd1n is an Abbe number of the negative lens G1n.

16. The optical system according to claim 1,
wherein at least one of the first lens group and the second lens group includes a positive lens Gp, and
wherein the following conditional expression is satisfied:
$$\begin{matrix}0.05 < Δ θ gFp < 0.25 , \\ where \\ Δθ gFp = θ gFp - ( B 3 \times {vdp}^{3} + B 2 \times {vdp}^{2} + B 1 \times vdp + B 0 ) , \\ B 3 = - 1.665 \times {10}^{- 7} , \\ B 2 = 5.213 \times {10}^{- 5} , \\ B 1 = 5.656 \times {10}^{- 3} , and \\ B 0 = 7.278 \times {10}^{- 1} ,\end{matrix}$$
and
where vdp is an Abbe number of material of the positive lens Gp, θgFp is a partial dispersion ratio, and ΔθgFp is an anomalous partial dispersion.

17. The optical system according to claim 1, wherein the following conditional expression is satisfied:
$$0.3 < ( DSP + sk ) / L < 0.8 ,$$
where DSP is a distance on an optical axis from an aperture stop to a lens surface closest to the image plane in the optical system in the case where the optical system is focused at infinity, and L is a total optical length of the optical system.

18. The optical system according to claim 1, wherein the following conditional expression is satisfied:
$$0.5 < f 1 / f < 5. ,$$
where f1 is a focal length of the first lens group.

19. The optical system according to claim 1, wherein a negative lens is located closest to the image plane in the third lens group.

20. An imaging apparatus comprising:
an optical system; and
a sensor configured to receive an image formed by the optical system,
wherein the optical system includes a first lens group having positive refractive power, a second lens group having positive refractive power, and a third lens group, the first, second, and third lens groups being arranged in order from an object side to an image side,
wherein the second lens group is configured to move relative to an image plane in an optical axis direction during focusing, and the first and third lens groups are configured to remain stationary with respect to the image plane during focusing,
wherein the first lens group includes three negative lenses that are consecutively arranged in the optical axis direction and located closest to an object plane,
wherein the second lens group includes two or more lenses, and
wherein the following conditional expressions are satisfied:
$$\begin{matrix}0.5 < f 2 / f < 3. , \\ 0.2 < sk / f \leq 1.075 , and \\ 0. < sk / \vert f 3 \vert < 0.8 ,\end{matrix}$$
where f is a focal length of the entire optical system, sk is an air-equivalent back focus in a case where the optical system is focused at infinity, f2 is a focal length of the second lens group, and f3 is a focal length of the third lens group.
